(19) United States
(12) Patent Application Publication
(10) Pub. No.: US 2013/0282160 A1
(43) Pub. Date: Oct. 24, 2013

(54) Method for Working Structural Members

(71) Applicants: Kevin Francis Fitzgerald, Sorrento (AU); Nathan Challen, Bonogin (AU)

(72) Inventors: Kevin Francis Fitzgerald, Sorrento (AU); Nathan Challen, Bonogin (AU)

(21) Appl. No.: 13/996,655

(22) PCT Filed: Dec. 22, 2011
(86) PCT No.: PCT/AU2011/001671

§ 371 Date: Jun. 21, 2013

(30) Foreign Application Priority Data
Dec. 22, 2010 (AU) 2010905618

(51) Int. Cl. G05B 15/02

(52) U.S. Cl. CPC G05B 15/02
USPC 700/145

(57) ABSTRACT

A computer supervised method if provided for fabricating articles defined in an electronic information source. The method is performed with a computer in communication with a computer controllable steel fabrication machine of a type that includes vises for holding and rotating a primary member of the article, for example a steel beam, under control of the computer. The method includes operating the computer to extract data from the information source including data defining primary members corresponding to each article. The computer then determines tasks be performed on the primary members by the fabrication machine to transform the primary members, e.g. steel beams, into the articles. The computer transmits a sequence of commands to the machine for carrying out the tasks on the primary members to thereby fabricate the articles.

### TECHNICAL FIELD

The present invention relates to a method for fabricating finished articles from structural members. In a preferred embodiment there is provided a method for fabricating structural articles such as finished steel beams by means of a computer controlled fabrication machine.

### BACKGROUND

The discussion of any prior art documents, techniques, methods or apparatus is not to be taken to constitute any admission or evidence that such prior art forms, or ever formed, part of the common general knowledge.

Structural members are commonly used in the building industry. Steel fabrication involves welding and cutting steel members, such as U-Beams, according detailed drawings. For example, FIG. 1 depicts a finished structural steel article 102 formed from a primary member in the form of a universal beam (“U-Beam”) 104.

The U-Beam 104 has been operated upon to incorporate a number of features according to a detailed shop drawing. The U-Beam has had notches 112 cut into its flanges. A secondary member in the form of a cleat 106 has been welded on. Furthermore, an end 114 of the U-Beam has been sliced at an angle to form a mitered end and a further secondary member in the form of an edge stiffener 108 has been welded on to the U-Beam. Bolt holes 110 have also been formed through the flanges of the U-Beam.

In order to transform a U-Beam to produce the article 102, a skilled tradesman must work from the shop drawings, which include dimensions indicating the positions and dimensions of the various features and the nature of the materials that must be used. The tradesman will use various tools such as welders and cutters to attach the cleat, cut the notches, weld the edge stiffener and miter the end of the U-Beam. These operations will typically take a number of hours.

There have been various approaches made in the past to automating the manufacture of finished articles by using robots. For example, in the automotive industry it is known to use robots which are trained by a human operator. During the training the robots remember the human operator's movements when working on a known component of a vehicle, for example a car door, in order to cut holes and make welds.

Furthermore, it is known to use CAM systems for producing products from blocks of metal. However, there remains a need for a more efficient way of working on metal members to produce articles such as that shown in FIG. 1.

It is an object of the present invention to provide an automated method for fabricating structural metal members that is an improvement over those methods that have been known in the prior art.

### SUMMARY OF THE INVENTION

According to a first aspect of the present invention there is provided a computer supervised method of fabricating articles defined in an electronic information source with a computer in communication with a computer controllable steel fabrication machine of a type including at least one assembly for rotating a primary member under control of said computer, the method including operating the computer to:
extract data from said information source including data defining primary members corresponding to each article;
determine tasks to be performed on the primary members by said fabrication machine to transform them into the articles; and
transmit a sequence of commands to said machine for carrying out said tasks on the primary members to thereby fabricate said articles,
wherein the sequence of commands includes commands for rotating the primary member for access by tools of said machine.

Preferably the at least one assembly for rotating a primary member comprises a pair of vises arranged to hold and rotate the primary member.

The step of extracting data from the information source may include determining secondary members attached to the primary members.

If a secondary member is determined to be attached to a primary member the tasks to be performed may include welding the secondary member to the primary member.

Preferably the method includes operating the computer to generate a fabrication shop drawing electronic file of each article from the digital information source for a human operator to refer to.

The method may include operating the computer to present the fabrication shop drawing on a computer display to the human operator prior to and/or during the step of carrying out the tasks on the primary member.

Preferably the method includes operating the computer to cause said machine to check that the primary member is correctly loaded in said machine.

Preferably the step to check that the primary member is correctly loaded includes operating a laser of said machine to check that the primary member is correctly loaded.

The method may include operating the computer to command the laser to perform checks to determine camber of the member to thereby allow for compensation for camber when carrying out the tasks.

Preferably the method includes operating the computer to check a cross section of the loaded member to confirm that the correct member corresponding to the tasks to be carried out is loaded in said machine.

The method may include operating the computer to check the correctness of a secondary member prior to welding it to a primary member.

The step of checking the correctness of the secondary member preferably includes operating a laser of said machine.

The method may include operating the computer to display a prompt for a human operator to confirm that ends of the member are true, for example square or at a predetermined angle.

Preferably the method includes operating the computer to cause the fabrication machine to render the end true.

In a preferred embodiment the method includes operating the computer to monitor signals from tools of the fabrication machine to confirm correct operation thereof.

Upon a tool being detected to not be operating correctly the computer may be operated to display a prompt for the human operator to check the tool.

Where the vises can be translated under control of the computer and where said machine includes one or more gantries that can also be translated under control of the computer, the method preferably includes operating the computer to move said vices and one or more gantries to thereby clear a path to ensure that a tool head for carrying out a task can be moved to a work area on the member unobstructed.

The step of extracting data from said information source preferably includes extracting identifiers for the primary members.

The method may include operating the computer to cause the fabrication machine to mark the primary members with markings corresponding to the identifiers for visual identification by human operators.

According to a further aspect of the present invention there is provided a computer software product comprising a computer readable media bearing tangible instructions for implementing the above-described method.

According to a further aspect of the present invention, there is provided a method for extracting data for operating a fabrication machine from an information source defining a number of articles, the method including the steps of:
extracting a member type for a primary member corresponding to each article; and
determining tasks to be performed upon primary members to produce corresponding articles taking into account the member type.

According to a further aspect of the present invention there is provided a computer software product comprising a computer readable media bearing tangible instructions for implementing the above-described method.

According to a further aspect of the present invention there is provided a method for processing a primary member with a computer controlled fabrication machine to thereby transform the primary member into a corresponding article, the method comprising:
ensuring that the primary member is correctly loaded into the machine; and
performing a sequence of predetermined tasks on the primary member with the fabrication machine for production of the corresponding article; wherein the tasks including attaching secondary members to the primary member.

According to a further aspect of the present invention there is provided a computer software product comprising a computer readable media bearing tangible instructions for implementing the above-described method.

According to another aspect of the present invention there is provided a method of fabricating articles defined in a digital information source, the method including:
extracting data from said information source including primary members corresponding to each article;
determining tasks to be performed on the primary members to transform them into the articles; and
producing a sequence of commands for carrying out said tasks on the primary members with a computer controlled fabrication machine to thereby produce the articles from said members.

According to a further aspect of the invention there is provided a computer programmed to carry out one or more of the previously mentioned methods.

### BRIEF DESCRIPTION OF THE DRAWINGS

The Detailed Description is not to be regarded as limiting the scope of the preceding Summary of the Invention in any way. The Detailed Description will make reference to a number of drawings as follows:

FIG. 1 illustrates an article fabricated from a primary member in the form of a steel U-Beam.

FIG. 2A depicts a steel fabrication machine for operation during the performance of a method according to a preferred embodiment of the present invention.

FIG. 2B is a close up of a vise of the apparatus.

FIG. 2C is a further view of the vise of the apparatus.

FIG. 2D is a view of a motor for moving a sled of the vise.

FIG. 2E is an end view of a motor of the apparatus showing a rotary encoder assembly.

FIG. 2F is a view of an upper section of a gantry of the apparatus.

FIG. 2G is a view of a tool mount of the apparatus.

FIG. 2H is a block diagram of a control system of the apparatus.

FIG. 2I is a view of the interior of a control cabinet of the control system.

FIG. 2J is a view of the apparatus during a further stage of operation.

FIG. 2K is a view of apparatus during yet another stage of operation.

FIG. 3 is a block diagram of a computer system that is operated during the performance of the method.

FIGS. 4 to 10 set out the steps that the Adaptor Software 116 of FIG. 3 carries out to process the third party architectural model 120 according to a preferred embodiment of the present invention.

FIGS. 11, 12, 14, 16 to 27B and 31 to 35 set out the steps of the method that is implemented by Job Management Software 118 of FIG. 3 in accordance with a preferred embodiment of the present invention.

FIGS. 13, 15 and 28 to 30 are screen shots of screens produced on display 136 during operation of the Job Management Software 118.

Preferred features, embodiments and variations of the invention may be discerned from the following Detailed Description which provides sufficient information for those skilled in the art to perform the invention.

### DETAILED DESCRIPTION OF PREFERRED EMBODIMENTS

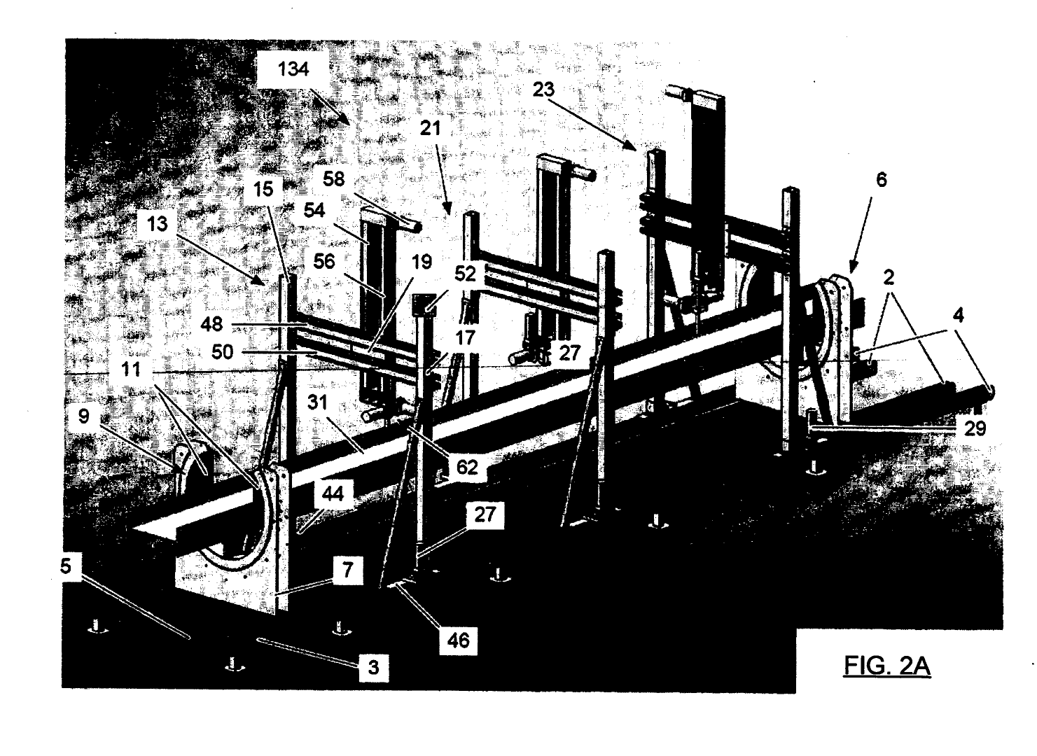

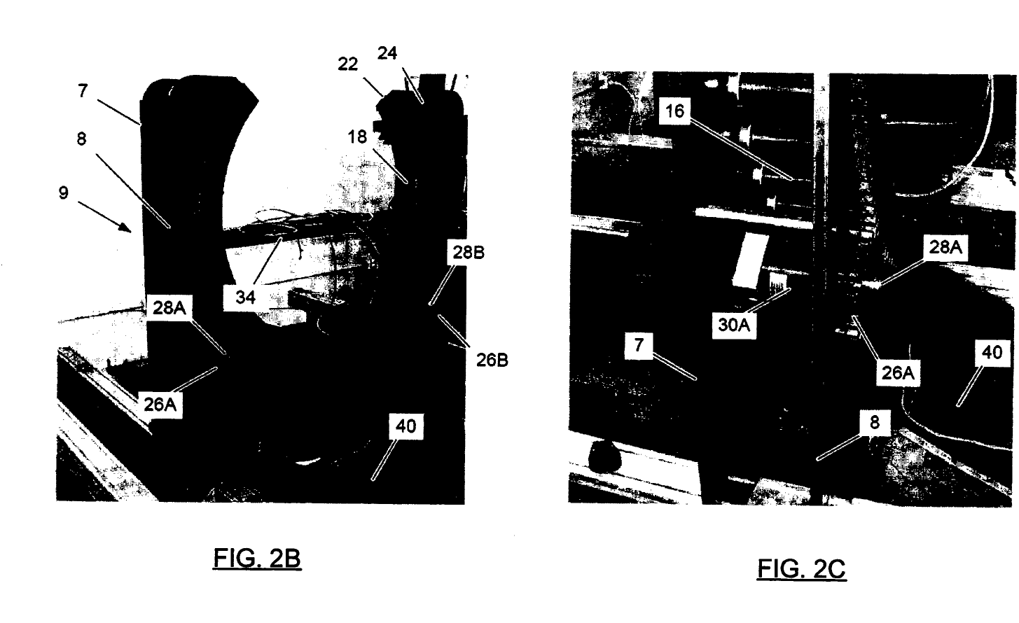

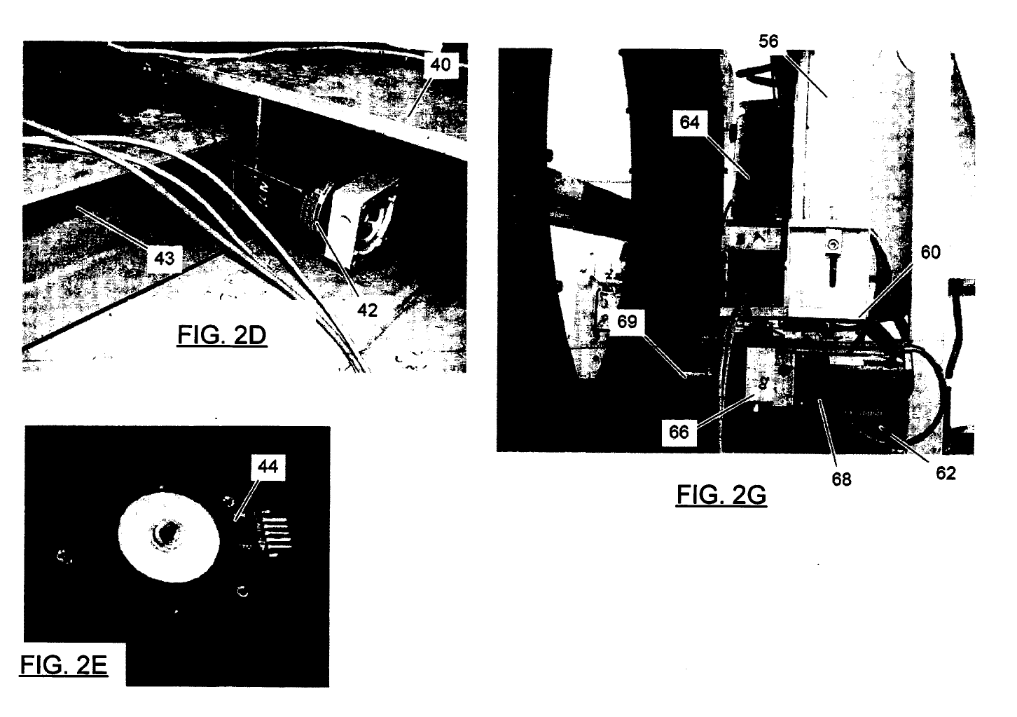

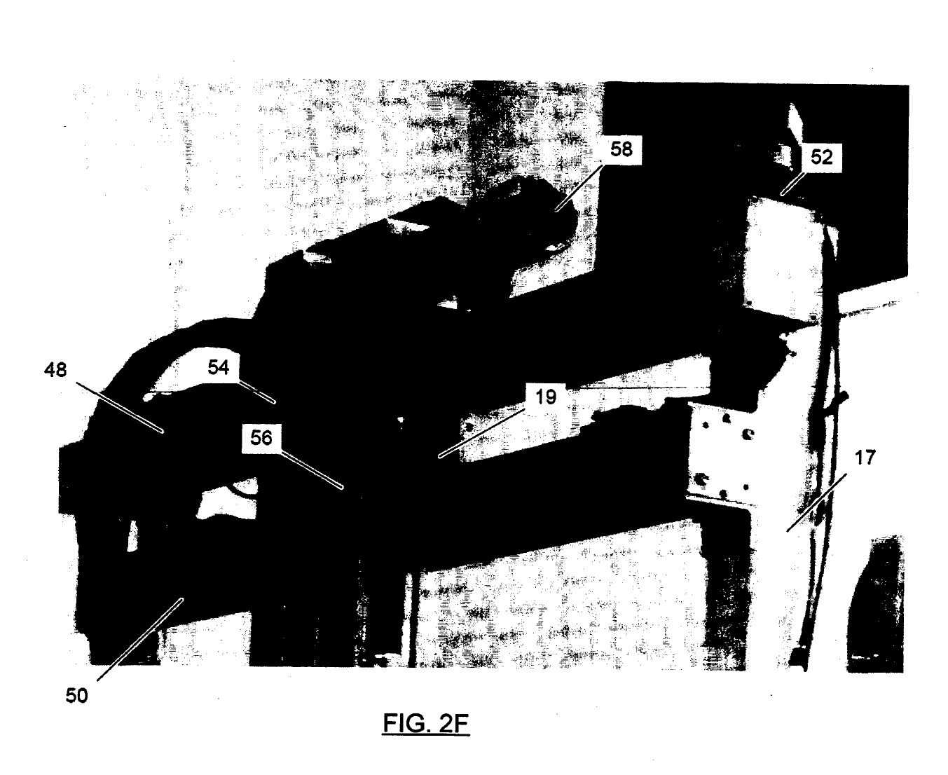

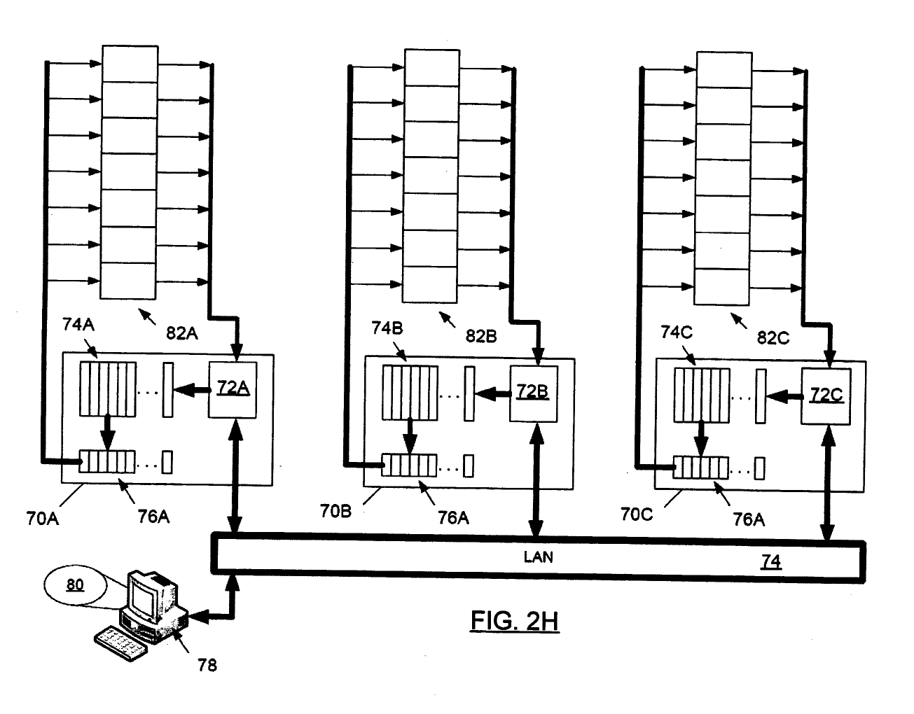

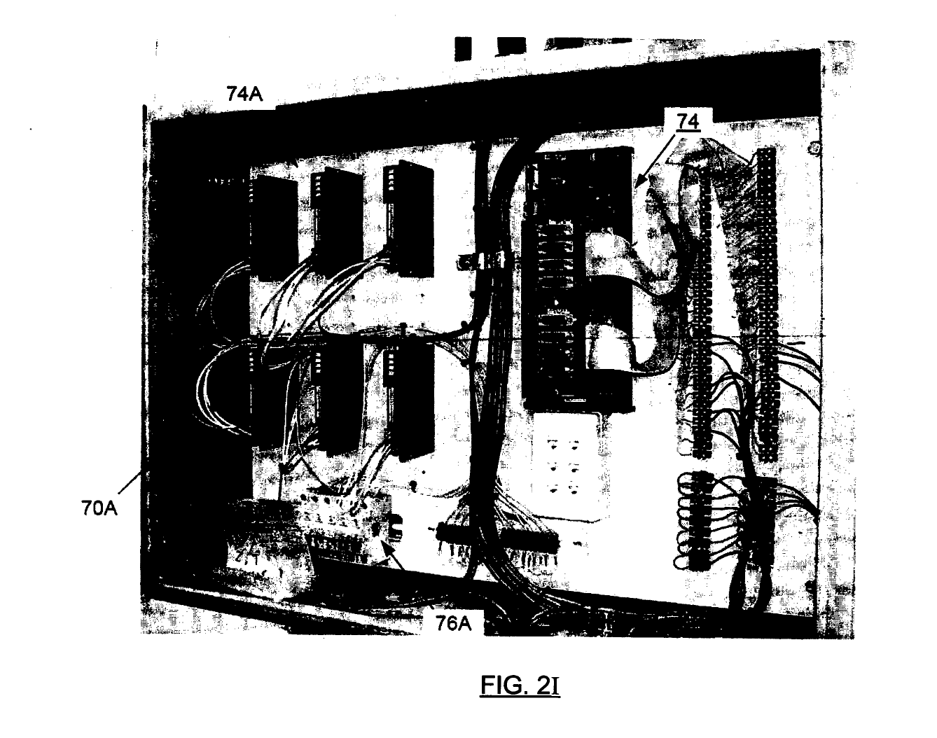

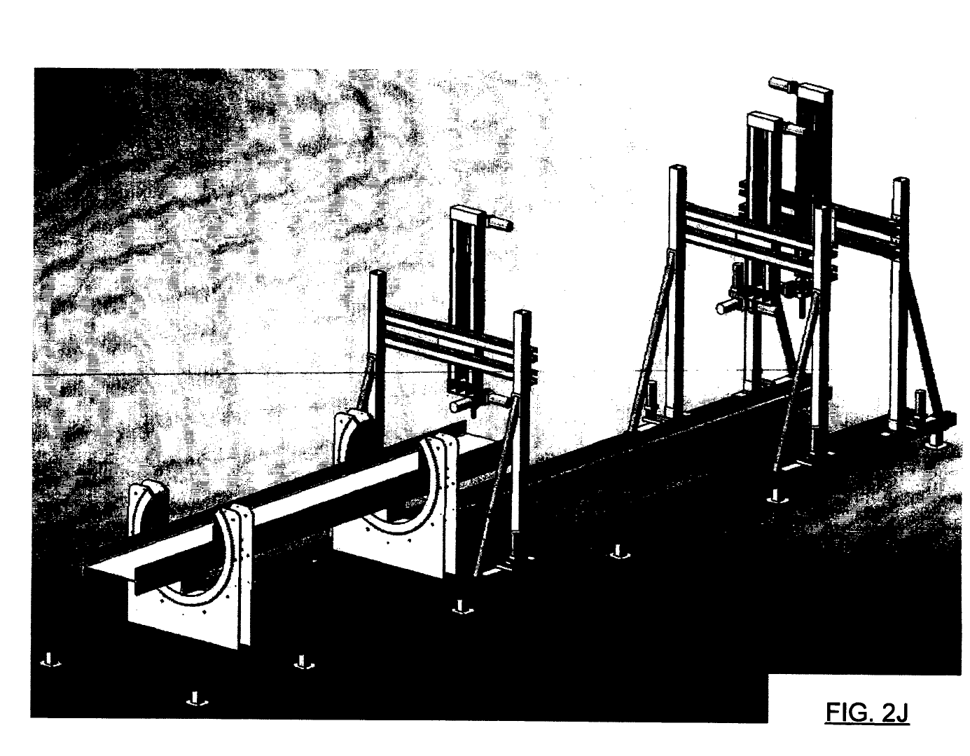

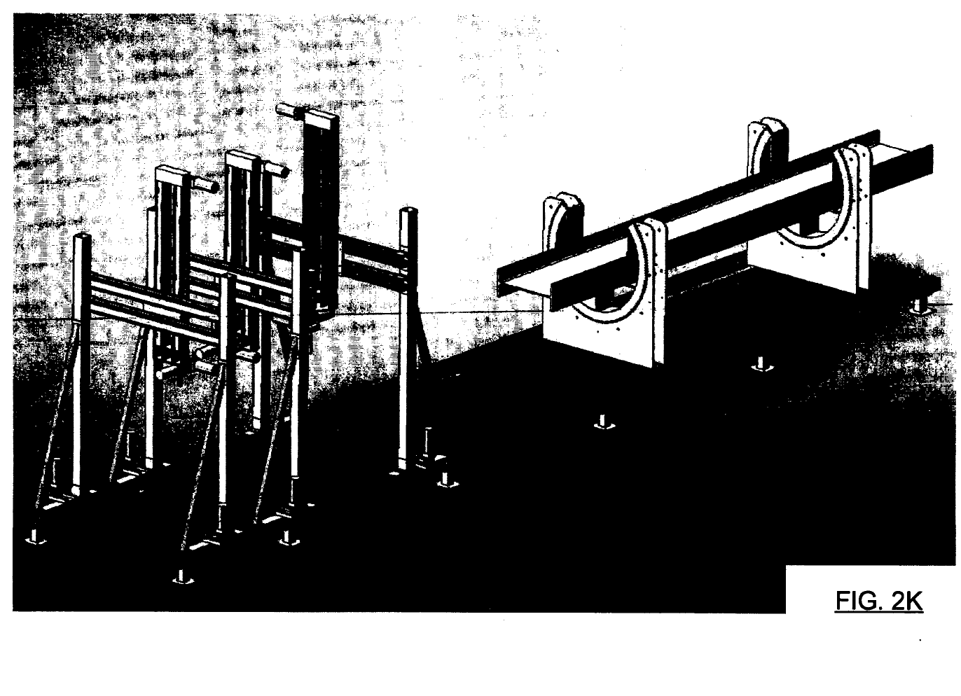

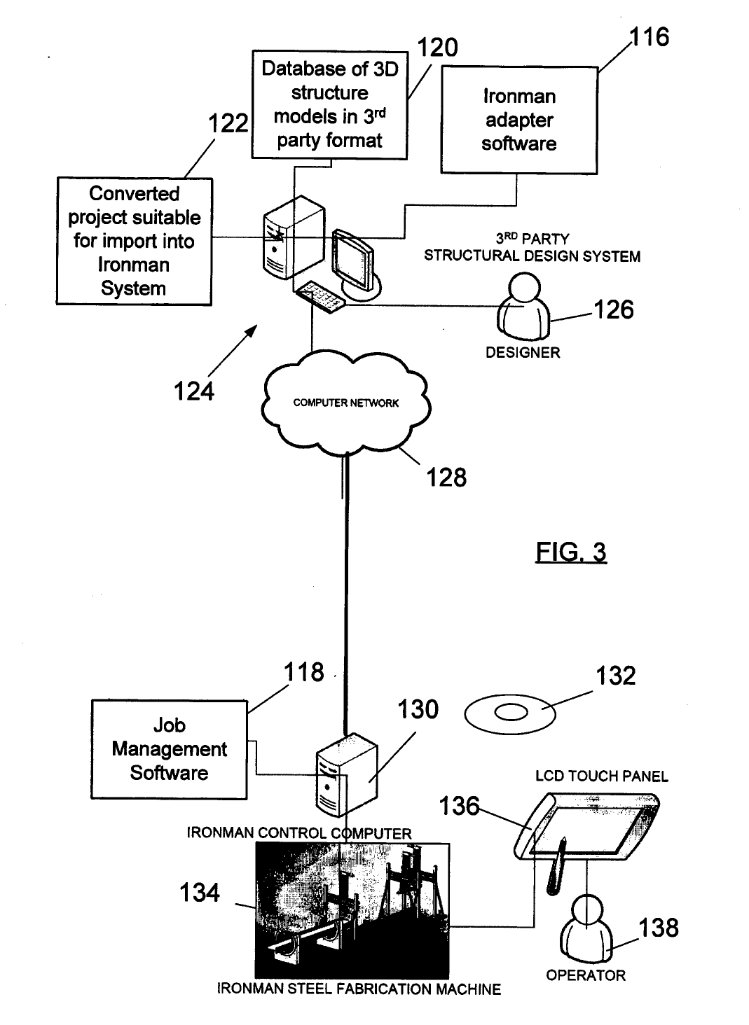

Referring now to FIG. 2A, there is depicted a beam fabrication machine 134 for working on steel members which may be variously referred to as the “Ironman” in the following description.

The beam fabrication machine 134 is shown loaded with a work piece in the form of a steel beam 31.

Fabrication machine 134 includes an inner pair of rails 2, and an outer pair of rails 4. Two rotatable vises, 9 and 6 ride along the inner pair of rails 2. FIGS. 2B, 2C and 2G show vise 9 in greater detail.

The arrangement of vise 6 corresponds to that of vise 9 which will now be described with reference to FIGS. 2B and 2C. The vise 9 is comprised of a stand in the form of an opposing pair of plates 7, 8 interconnected by bearing rollers 16 which are disposed in an arc about corresponding central arcuate cutouts formed through each plate. The bearing rollers support an arcuate cradle 18 that is located within the cutout and is flanged with opposing arcuate flanges 22 and 24 that overhang the outer sides of plates 7, 8 about the edges of the respective cutouts. The periphery of flange 24 is toothed and meshes with teeth of step down cogs 26A, 26B. Each step down cog 26A, 26B is fitted to respective spindles 28A, 28B of servo motors 30A, 30B (not visible). The servo motor 30A is fitted with a positional encoder 44 (visible in FIG. 2E) in order that a control system, which will be described shortly, is able to monitor the position of the spindle and hence the angle of cradle 18.

Fitted across the inside of the cradle is a support bench 34 upon which opposing slideable jaws 11 (visible in FIG. 2A) are fitted. The slideable jaws 11 are arranged to cooperate to hold a work piece, which is usually an elongate metal member, such as steel beam 31.

The vise 9 further includes a sled 40 which supports the opposed plates 7 and 8 of the stand and includes wheels (not shown) to roll between inner rails 2. With reference to FIG. 2D, servo motors 42 are fitted on either side of the underside of sled 40. The servo motors 42 have spindles that are fitted with corresponding pinions (not shown) which mesh with respective racks 43 fastened along the inside of rail 2. Consequently, in use the servo motors 42 are able to precisely translate vise 9 along the inner rails 2. Furthermore, the position of the vise 9 can be determined by monitoring signals from a rotary encoder of the servo motors 42.

Referring again to FIG. 2A, and also to FIG. 2F, a translation assembly comprising three gantries, 13, 21 and 23, ride along outer rails 4. The gantries are of similar construction and will be described with reference to gantry 13. Gantry 13 is comprised of a pair of upright posts 15 and 17 which extend upward from respective bases 44, 46. The bases 44 and 46 are fitted with servo motors 27 that are coupled to the outer rails 4 by means of a rack and pinion arrangement similar to that previously explained with reference to vise 9. Accordingly, gantry 13 can be precisely moved, i.e. translated, along outer rails 4 by an electronic control system as will be described in due course.

Parallel cross rails 48 and 50 span the upper ends of posts 15 and 17. A carriage 19 is fitted across cross bars 48 and 50 and arranged to slide along them. A drive band is fitted within the upper cross rail between opposing sprockets and arranged for rotation by a servo motor 52 fitted atop of post 17. The drive band is coupled to carriage 19 so that by operating servo motor 52, carriage 19 may be accurately positioned along cross bars 48 and 50 as desired.

A pair of parallel, vertical rails 54 and 56 slidingly engage carriage 19. The vertical rails 54 and 56 may be raised and lowered relative to carriage 19 via operation of servo motor 58.

The servo motor 58 is coupled to a drive band that is fitted within vertical rail 56 and which engages with carriage 19 in order to raise and lower rails 54 and 56 relative to the carriage.

A multiple axis tool mount assembly 62 is fitted at the lower end of rails 54 and 56 as shown in FIG. 2G. The tool mount assembly 62 comprises a horizontal support plate 60 upon which a panning servo motor 64 is mounted. The spindle of panning servo motor 64 protrudes through an opening in support plate 60 and is attached to a vertical yoke 66 which supports a roll servo motor 68. Consequently a tool, for example a plasma cutter (not shown) fitted to the spindle of roll servo motor 68, can be moved about five axes of motion. Apart from a plasma cutter, other tools that may be interchangeably fitted to the tool mount include a welder, marker, spray paint head, electromagnet, laser position detector and a drill. The tool mount may be simultaneously fitted with more than one tool. For example two tools, faxing in opposing direction may be fitted in some circumstances so that each can be rotated into position for use when required.

The five axes of motion of the tool mount assembly include three translation axes being Y-translation, along the outer rails by virtue of servo motor 27, X-translation along cross bars 48, 50, by virtue of servo motor 52, Z-translation of the vertical rails 54 relative to cradle 19, by virtue of stepper motor 25. There are also two rotational axes of motion being rotation about the spindle of pan servo motor 64 and rotation about the spindle of roll servo motor 64. The tool mount of gantry 23 is similarly a 5-degree arrangement in the same fashion as that of gantry 13. However, gantry 21 includes an additional tilt servo motor coupled, at right angles, between pan servo motor 64 and roll servo motor 68 in order to provide a tool mount with six degrees of motion.

A block diagram of the controller system is shown in FIG. 2H. The controller system includes three controller cabinets, 70A, 70B, 70C, corresponding to each Gantry. FIG. 2I shows the interior of cabinet 70A. Each controller cabinet contains a Galil controller board 72A, 72B, 72C, that is coupled to a corresponding PWM servo amplifier array 74A, 74B, 74C that in turn drives an array of servo motors 82A, 82B, 82C associated with the gantries, vises and tool mounts. Circuit breaker arrays 76A, 76B, 76C protect the servo amplifiers and the servo motors from over-current surges.

The controller boards 72 each receive encoder data from the servo motors that they control. Each controller board is separately addressable on Ethernet network 74 and communicates with master PC 78. The master PC 78 executes a program 80 that includes instructions to process steel fabrication shop drawings, extract relevant data, prompt for user input and convert the extract drawing data and user inputs into controller board commands addressed to the appropriate controller boards.

The program 80 is stored on secondary storage of the PC 78, such as a magnetic or optical disk.

In response to the commands from the PC 74, the controller boards operate the servo-motors to carry out the fabrication operations. They also pre-process and relay encoder data from the servo motor encoders back to the PC 78.

The controller boards 72A, 72B, 7C comprise three Gaul control boards. These are Ethernet addressable boards that can each control systems with up to eight motion axes. The Ethernet motion controllers are designed for extremely cost-sensitive and space-sensitive applications. The controllers are designed to eliminate the wiring and any connectivity issues between the controller and drives. Plug-in amplifiers are available for driving stepper, brush and brushless servo motors up to 500 Watts. Alternatively the boards can be connected to external drives of any power range.

Galil controllers are available from Galil Motion Control, 270 Technology Way, Rocklin, Calif. 95765, USA.

In use, the centre balanced vises 9 and 6 grip the beam 31 with jaws 11 and, by operation of their servo motors, e.g. servo motor 30A and 30B of vise 9 rotate arcuate cradle 18, thereby rotating the beam about its long axis. As a result the tool mounts, e.g. tool mount 62 of gantry 13 are able to access all sides of the beam. Furthermore, since the tool mounts operate with a number of degrees of freedom, the tools that are mounted to them are able to operate at virtually any angle on any side of the beam.

As an example of an embodiment of a method of operating the apparatus, suppose that it is desired to weld a component, such as a cleat to the beam at a predetermined position. Cleats are stored in a predetermined storage area, for example a cassette, mounted on or nearby the apparatus.

After the beam has been located in the opposing vises it is rotated so that the location on the beam for the cleat to be attached is available to the welding tool head. A laser measuring tool head then checks that the beam is correctly positioned and that the cleat is correctly orientated in the cassette. This last step may involve checking that asymmetrical slots, other apertures, edges or markings of the cleat are the correct way up.

Provided that the cleat is correctly orientated an electromagnetic head then operates to hold the cleat and move it to the correct position on the beam for welding. A welding head then operates in concert with the electromagnetic head to weld the cleat to the beam. It will be realised that in this method the translational assemblies in the form of the gantries, to which the electromagnetic head, laser head and welding head are mounted, all move up and down the length of the beam in order that the tool heads can carry out the various operations. During execution of this method the servo motors on the tool head mount, and the various gantry and vice servo motors, are all operated and monitored, i.e. controlled by the control system illustrated in FIG. 2H.

FIGS. 2J and 2K show the fabrication machine 134 during various stages of working with the gantries and vises having having been slid along rails 2 and 4 to various positions.

The machine may be further operated to:
i) cut the work piece to length, with square, angled, simple curved or complex curved cuts.
ii) cut holes on any face of the work piece.
iii) apply an identification mark to the work piece.
iv) hold cleat in place ready for welding.
v) tack weld a cleat.
vi) fully weld a cleat.
vii) spray paint the finished item with a spray paint head.

During its operation, relative motion between the tool mounts and the workpiece, e.g. the beam, may be achieved by either keeping the vises stationary and moving the tool or moving both the work and the tool simultaneously. The controller system can be programmed to process multiple small parts from the one length of material, with the work area remaining stationary and the material being fed into the work area after the last part has been processed.

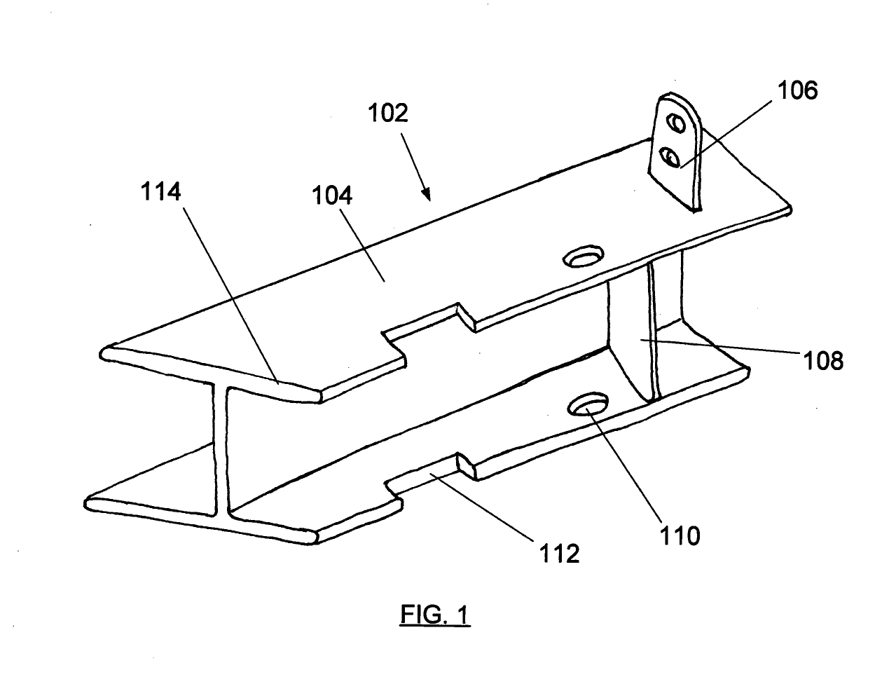

The steel fabrication shop drawings that were previously referred to in the discussion of FIG. 1 and which are used to guide the tradesman in fabricating the article of FIG. 1 may be generated from an information source such as the 3^{rd} party model of the structural steel. Such a model typically comprises a three dimensional architectural drawing of the building in which the article is to be used.

The present inventors have developed a method for fabricating structural metal articles, such as that depicted in FIG. 1, using an apparatus such as the Ironman that was previously described with reference to FIGS. 2A to 2K. In a preferred embodiment this method involves extracting information from the three dimensional architectural drawing and generating a list of tasks. The tasks are for the Ironman to perform upon one of a number of types of primary member, to fabricate the articles defined in the drawing. The preferred method then includes checking that the appropriate member has been loaded into the Ironman for each task and then sending commands to the various motors and tools of the Ironman to carry out the task.

FIG. 3 is a block diagram of a system that includes an Adaptor Software package 116 and a Job Management Software package 118, each according to a preferred embodiment of the present invention.

With reference to FIG. 3, an information source, in the form of a database of 3D structure models 120 is provided, which comprises a third party architectural drawing. The architectural drawing has been created by a designer 126 using a 3^{rd} party structural design system 24 comprising a structural steel CAD package running on a suitable computer system.

An Adaptor Software module 116 is provided according to an embodiment of the present invention. The Adaptor Software module interfaces with the database of the architectural drawing 20 using an API. Consequently, the Adaptor Software 116 may be interfaced with a number of different architectural software packages by use of different dedicated APIs for each package.

The Adaptor Software interrogates the architectural drawing database 120 and extracts data defining the articles for fabrication that are stored therein. The details of the articles are stored in an SQL database 122 for importation into the Job Management Software 118 via a computer network 128.

The Job Management Software 118 runs on a control computer 130 which is interfaced to the Ironman fabrication machine 134 so that the control computer is able to receive data from the various encoders and sensors of the fabrication machine and transmit commands to operate its various motors, actuators and power tools. One version of the interface is depicted in FIG. 2H where computer 130 of FIG. 3 corresponds computer 78 of FIG. 2H and software product 132 of FIG. 3 with software 80 of FIG. 2H. The software may be provided as tangible machine executable instructions provided on a machine readable media 132 such as an optical or magnetic disk or a solid state memory device.

A human-machine interface is provide in the form of LCD touch panel 136 for an operator to interface with the control computer 130 and the fabrication machine 134 while the software 118 is being executed. In FIG. 3 the LCD touch panel is shown connected to the fabrication machine machine 134 however it will be understood that it is also in communication with the control computer 130 and provides an interface for the operator to that control computer.

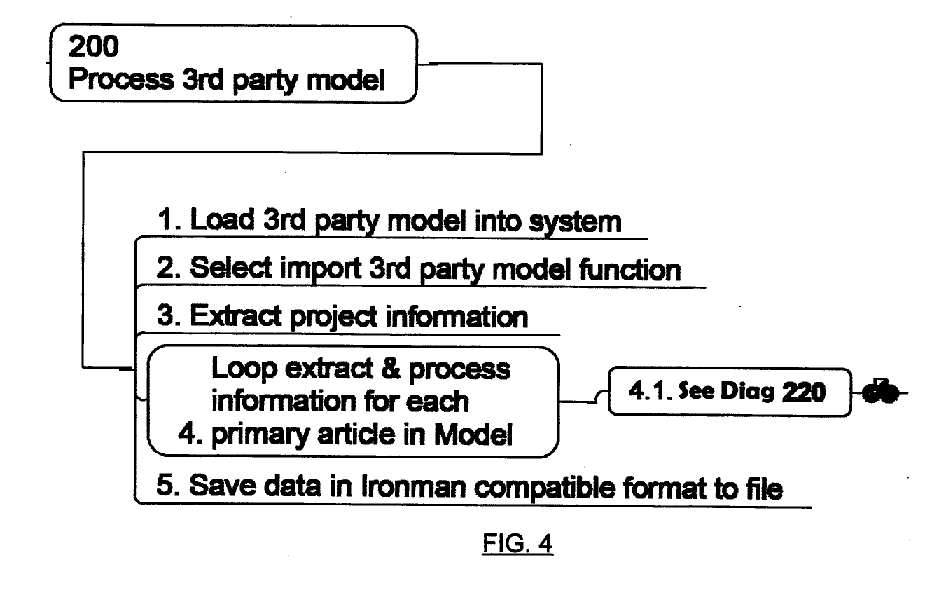

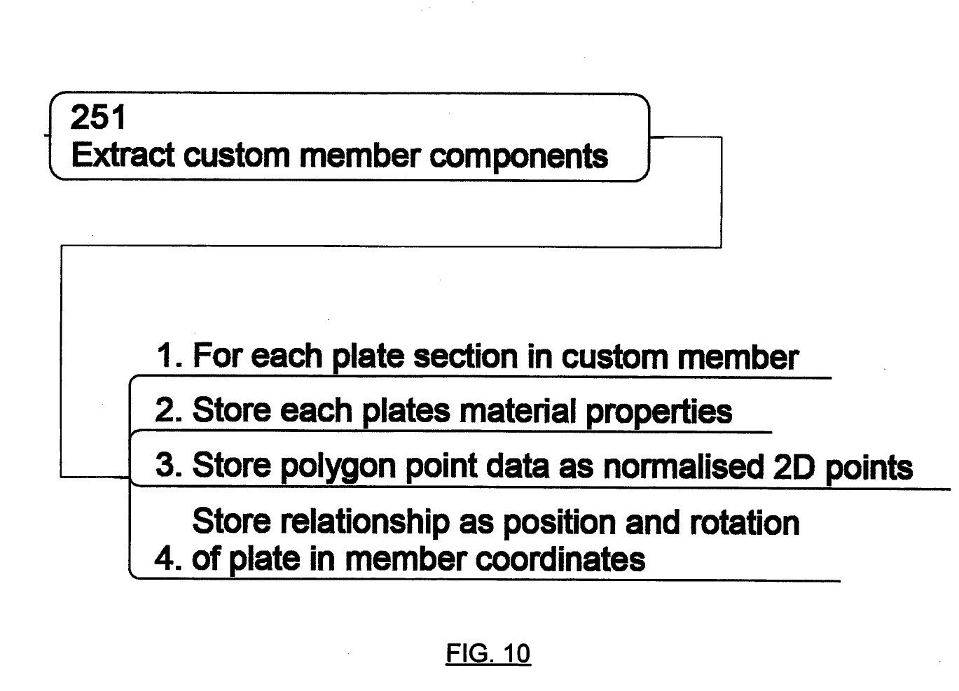

The steps that the Adaptor Software 116 carries out to process the third party architectural model are depicted in the “200” series of software diagrams that comprise FIGS. 4 to 10. These steps are coded as instructions in the software and stored as tangible machine readable instructions on the media 132 for execution by control computer 130. Accordingly, in use the control computer 130 is programmed to carry out the method described herein.

The control computer 130 under while executing Job Management Software package 118, interrogates the SQL database 122 and generates a list of tasks for the Ironman to carry out in order to fabricate the articles that are described in the 3D model 120.

The control computer 130 then issues commands to the Ironman Steel Fabrication Machine 134 for it to carry out a task, i.e. a sequence of operations on a primary member, to create a finished article, for example as shown in FIG. 1. The operator 138 interfaces with the Job Management Software 118 during this process and is presented with various messages and prompts for user input to confirm that various steps have been carried out. The steps that the Job Management Software module carries out in order to implement the tasks and drive the Ironman 134 to fabricate the articles are depicted in the “300” series of software diagrams that comprise FIGS. 11, 12, 14, 16 to 27B and 31 to 35.

The Job Management software 118 can work with different types of machines other than that described with reference to FIGS. 2A to 2K. Different driver level modules may be used for different Ironman machines. For example, if the gantry arm dimensions or motor controllers of the Ironman are changed in other versions of the machine then that would not affect the high level code of the software. The driver level modules include routines to move the gantries without them colliding. Consequently it is possible to cut a hole at opposite ends of a member for example. SAFE DRIVE, which is one of the driver level modules, may involve rotating a member by operating the motors that control rotation of the vise cradles for example.

In a preferred embodiment of the invention the software is configured to store the parameters of a number of types of structural member as follows:

A Rectangular Hollow Section (RHS) which has a rectangular profile. The parameters that the software stores for an RHS are member length, width, height, corner radius, wall thickness and a marking, which is an identifier from the original 3D architectural drawing model.

A Square Hollow Section (SHS), which has a square profile. The parameters for the SHS are the same as for the RHS except that the width equals the height.

A Universal Beam (U-Beam or “I” beam) which has a central vertical web and opposed flanges. The parameters are length, width, inside flange to web radius, flange thickness, web thickness, outside radius of the outside corners of the flanges, a marking.

Pipe: length, outside diameter, thickness, marking.

PFC (Parallel Flange Channel): Length, width, inside radius, web thickness, flange thickness, marking.

Plates: width, height and thickness. Slot and hole parameters for slots and holes of the plate. These are stored as X,Y coordinates relative to a corner of a side of the plate to be welded to the primary member. For example a circular hole is stored as (x,y,r). A slot is stored as (x1,y1, x2,y2, r) where x1,y1 is the position of one end of the slot, x2,y2, is the position of another end of the slot and r is the radius of the circle about each end and half the width of the slot.

Cleats are a type of plate.

Custom member is an engineered member for a particular application. All components are laser cut plates and welded for interconnection.

The data for a custom member is stored as the data for a series plates. The modeling system stores welds to interconnect plates, including the type of weld. If the plates for a custom member come within 1 mm then they are deemed to be welded together.

A member coordinate system is used for each member with a coordinate zero at an end of each member.

In the software the fundamental members described above are modelled as data objects and inherited attributes are used.

The markings that are stored for each member are alphanumeric characters. At the end of the fabrication process the markings are welded or scribed on the top face of the associated member. Consequently the markings can be viewed by human assemblers to assist them in putting the articles together to form the steel structure.

Referring now to FIG. 4, there is depicted a high level diagram 200 of the steps carried out by the Adaptor Software package 116 that is shown in FIG. 3, for processing the information source, comprised of the 3^{rd} party model 120, to produce the database 122.

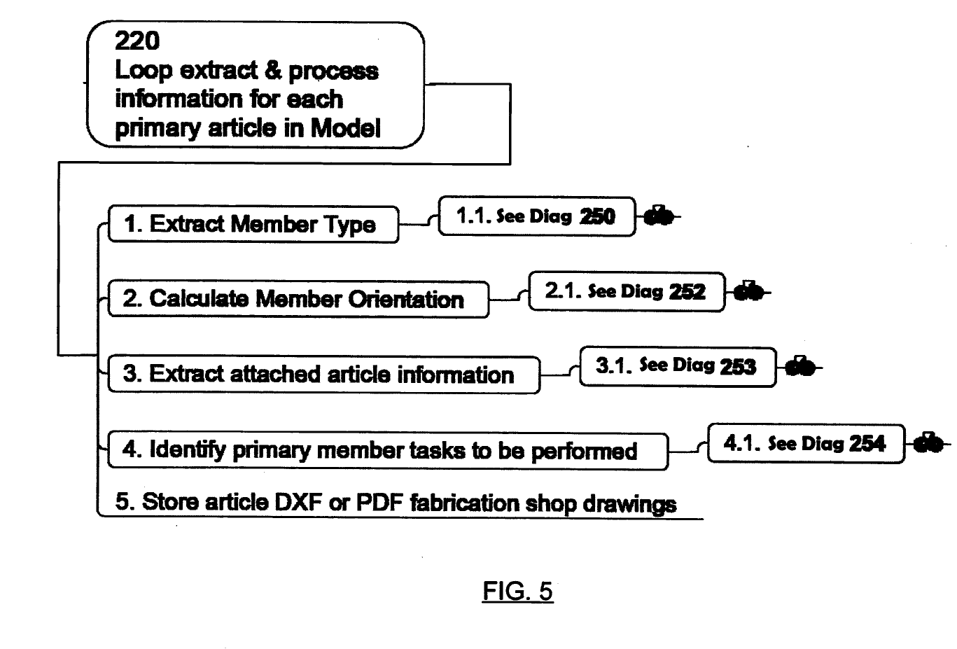

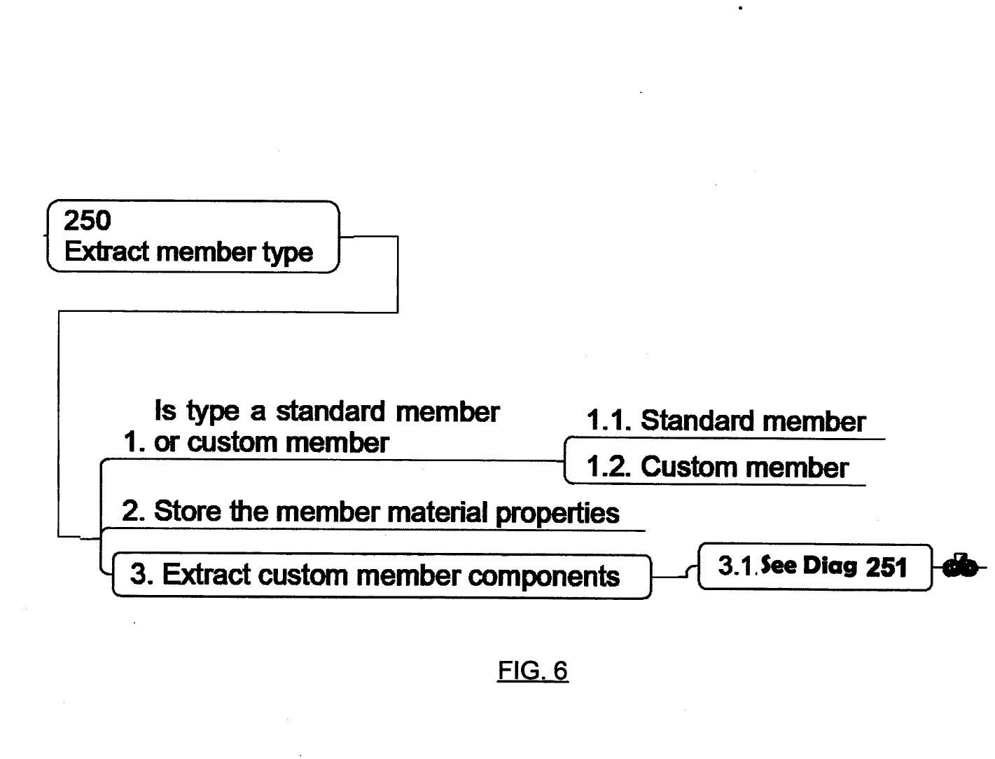

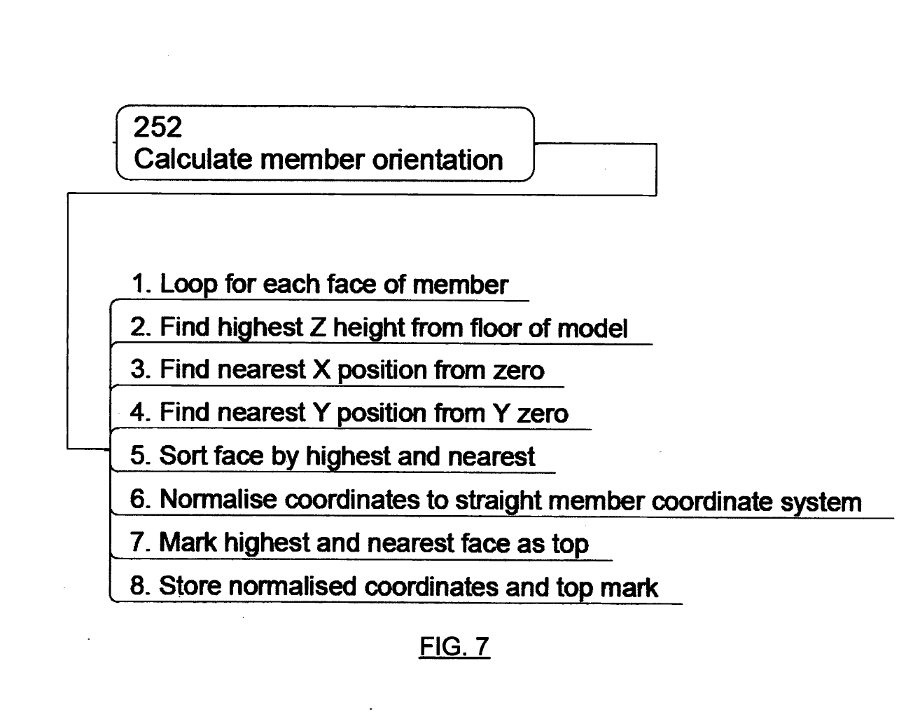

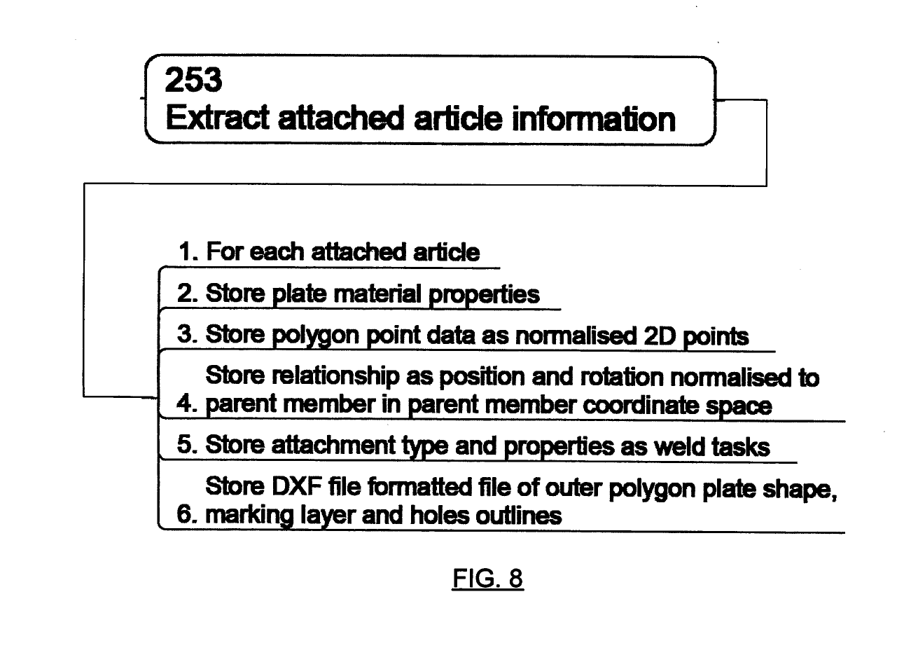

With reference to FIG. 4, initially the 3^{rd} party model, for example a file derived from an information source in the form of database 122, containing all of the information describing the building that is the subject of the model, is loaded into Job Management Software 118. The operator 138 is then prompted to select an option for importing the 3^{rd} party model. The software then extracts the project information, being the information about the articles, that is the fabricated steel members, such as the article referred to in FIG. 1. In order to extract the data the software loops and processes information for each primary member in the model. Details of the data extraction and processing steps carried out by the Adaptor Software 116 (FIG. 3) are set out in diagram 220 (FIG. 5) and its sub-flowcharts 250, 252, 253, 254 shown in FIGS. 6, 7, 8 and 9.

### 200—FIG. 5—Extract and Process Information for Each Primary Member in Model

The procedure for extracting and processing information for each primary member in the model involves:

250—FIG. 6—Extracting a member type, i.e. one of the types discussed above and including, if it is a custom member, storing the member material properties and if it is a custom member, extracting the custom member components which comprise a plurality of plates (251) and normalising their coordinate data;

252—FIG. 7—Calculating the member's orientation. This involves checking each face of the member for highest, i.e. largest, (x, y, z) coordinates. The determined (x, y, z) coordinates are then used to sort the faces in order of highest and nearest. The highest and nearest face is then flagged as the “top” face and normalised coordinates for the member are stored and the top is marked.

253—FIG. 8—Extracting attached member information (220). For example it may be that secondary members in the form of cleats or edge stiffeners are welded to the primary member. These secondary members are invariably some form of plate. As shown in FIG. 8 (253), the step of extracting attached secondary member information includes storing the plate's material property, its normalised point data and its spatial relationship to the primary, i.e. “parent” member in the primary member's coordinate space.

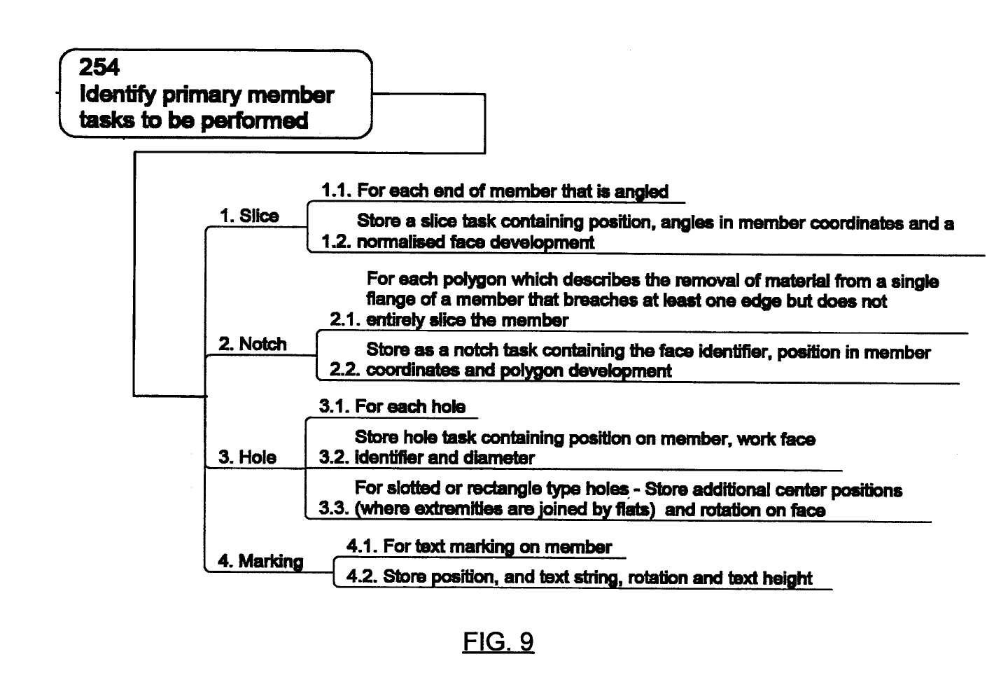

254—FIG. 9—Identify Primary Member Tasks to be Performed. This routine involves identifying the operations, that is “tasks”, which must be carried out on the primary member in order to transform it for production of the finished article.

The types of tasks that need to be performed are Slice, Notch, Hole, and Marking. Each task is stored as a sequence of coordinates and operations specifying the tool heads of the Ironman that are to be used to implement the task and identifying the positions on the primary member where the tasks are to be carried out.

It is at this stage that the attachment type and properties are stored as weld tasks. The weld tasks comprise information that can be used to operate the Ironman to weld a secondary member, i.e. a plate, to the primary member. This information includes the length and type of the weld.

Finally a DXF (i.e. drawing exchange format) file is produced of the outer polygon plate shape, marking layer and holes outlines. This drawing provides a visual representation of the plate that can be displayed during its attachment to the primary member so that an operator can check that the correct plate is being used and being attached.

The extraction and processing steps referred to above are carried out by the Ironman Adaptor Software 116 shown in FIG. 3. At the completion of the extraction and processing steps the 3D Structure Model 120 has been converted into a database 122 containing a sequence of primary and secondary members, their interrelationships and the tasks that must be carried out by the Ironman in order to transform the primary and secondary members into the articles originally specified in the 3D Structure Model 120. This database, which may be an SQL database or an XML document, is represented in FIG. 3 as the box “Converted Project Suitable for Import into Ironman System” 122.

The Ironman Job Management Software, shown in FIG. 3 processes the Converted Project and generates commands to operate the Ironman in order for it to produce the various articles specified in the original 3D Structure Model 120.

An overview of the method that is coded in the Ironman Job Management Software 118 is provided in diagram 300 shown in FIGS. 11 and 12.

### 300—Process Member—FIGS. 11 and 12

Initially an article is selected for processing, i.e. fabricating by the Ironman. The article can be selected by the human operator scanning or manually inputting an article identification code or simply by the article being the next one in an article processing list.

The member's parameters are then loaded and the list of processing tasks for the selected article is also loaded. The parameters and processing tasks are retrieved from the previously created databases.

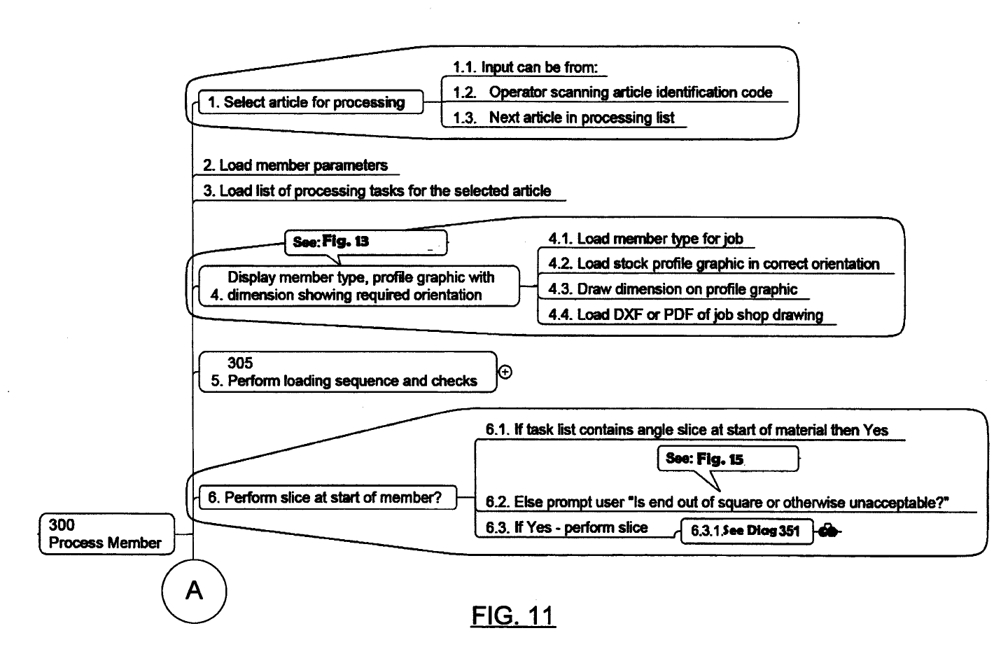

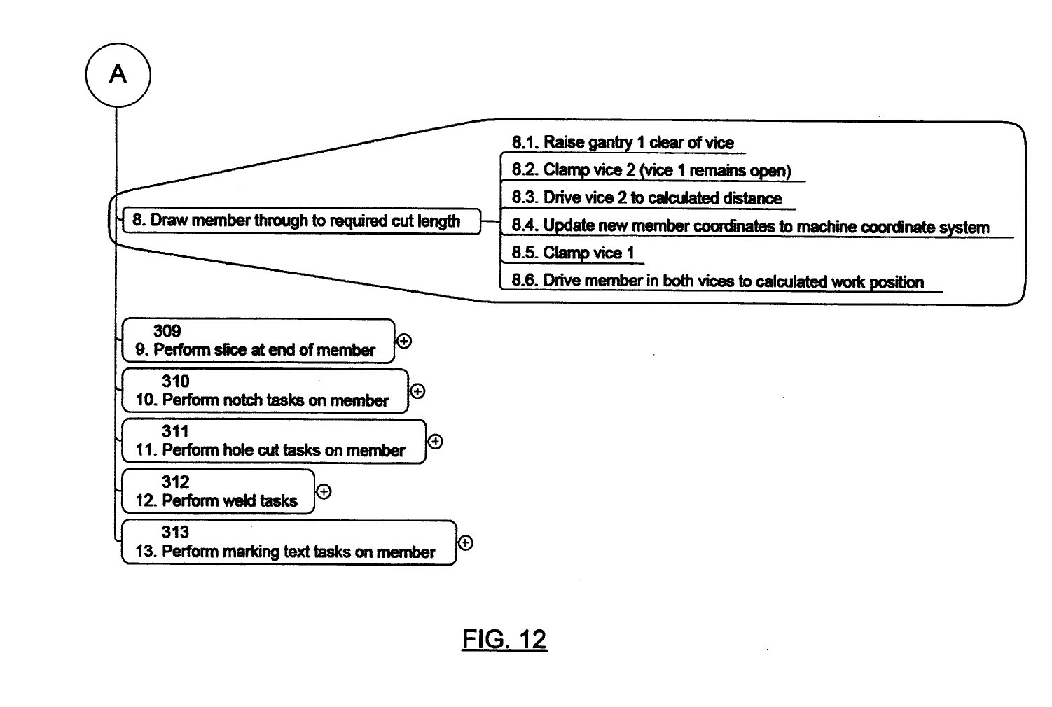

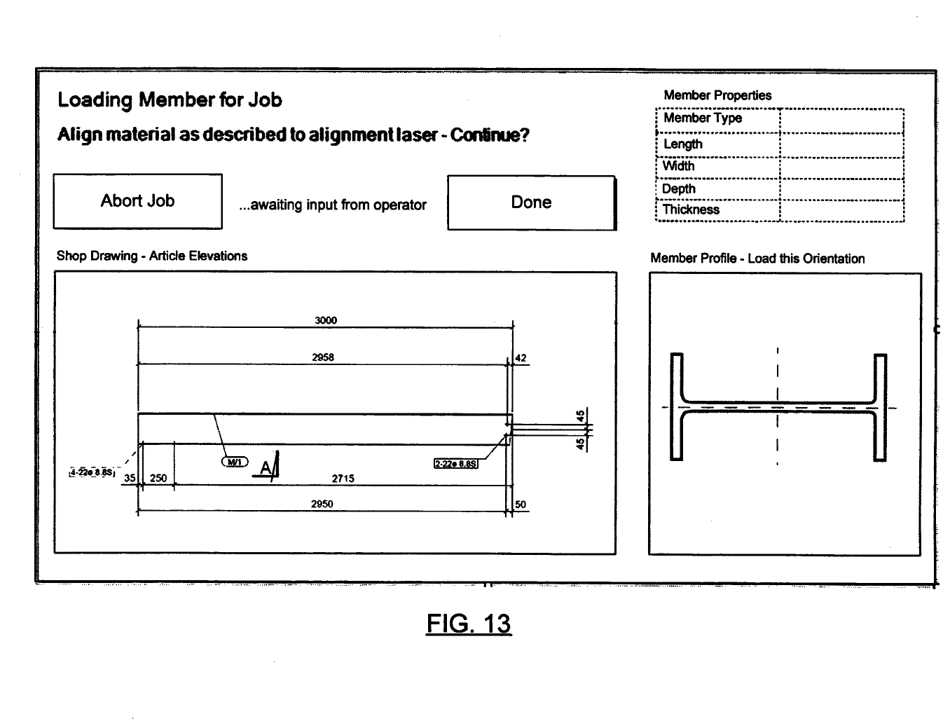

At item 4 of 300 a screen is generated on the LCD display 136 of FIG. 3 to assist the human operator in loading the correct member into the vises of the Ironman. The screen that is displayed is shown in FIG. 13 and includes a shop drawing of the member profile and the article elevations. This assists the human operator in ensuring that the correct type of member is ready for loading into the Ironman vises. Once the member has been correctly identified the human operator confirms by clicking on the “Done” button in the screen of FIG. 13.

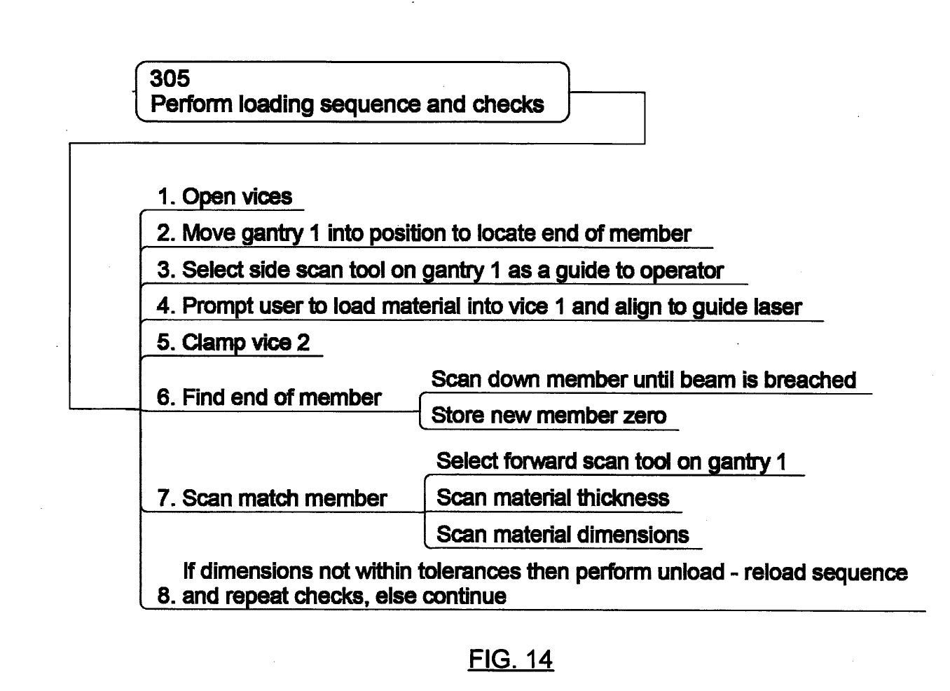

### 305—FIG. 14—Perform Loading Sequence and Checks

The sequence for loading a primary member into the Ironman includes opening the vices and moving Gantry 1 (shown as item 13 in FIG. 2A) into position to locate an end of the member. The end of the member is laser scanned by a laser on the tool head of Gantry 1 to ensure that the member has the correct material thickness and dimensions. If the scanned dimensions are not within tolerances then the system will not proceed but rather will prompt for the operator to reload the Ironman and will then recheck that the reloaded member is of correct dimensions and material thickness.

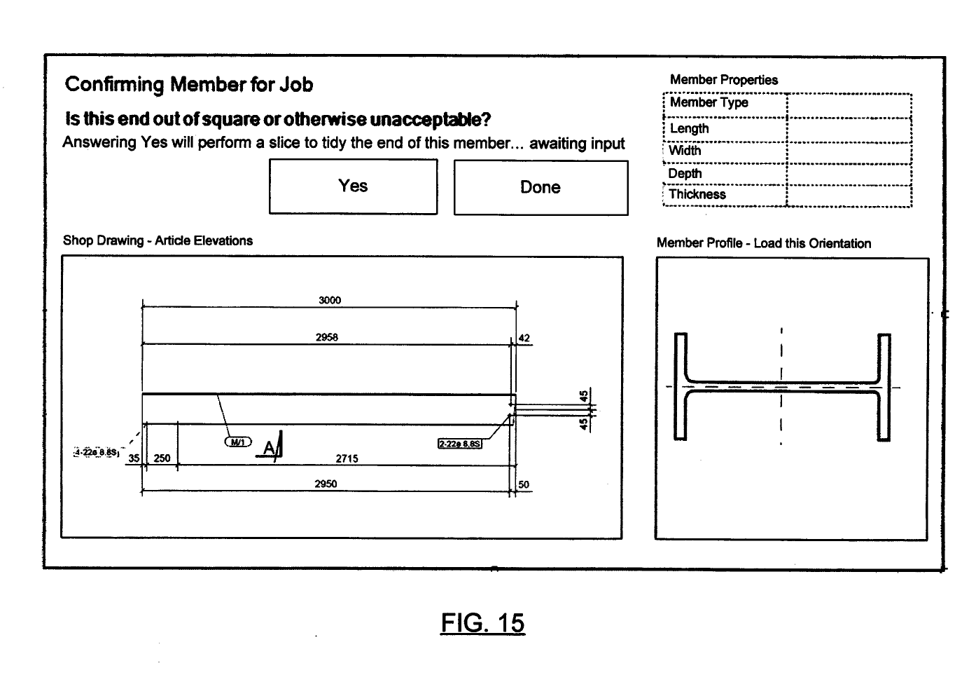

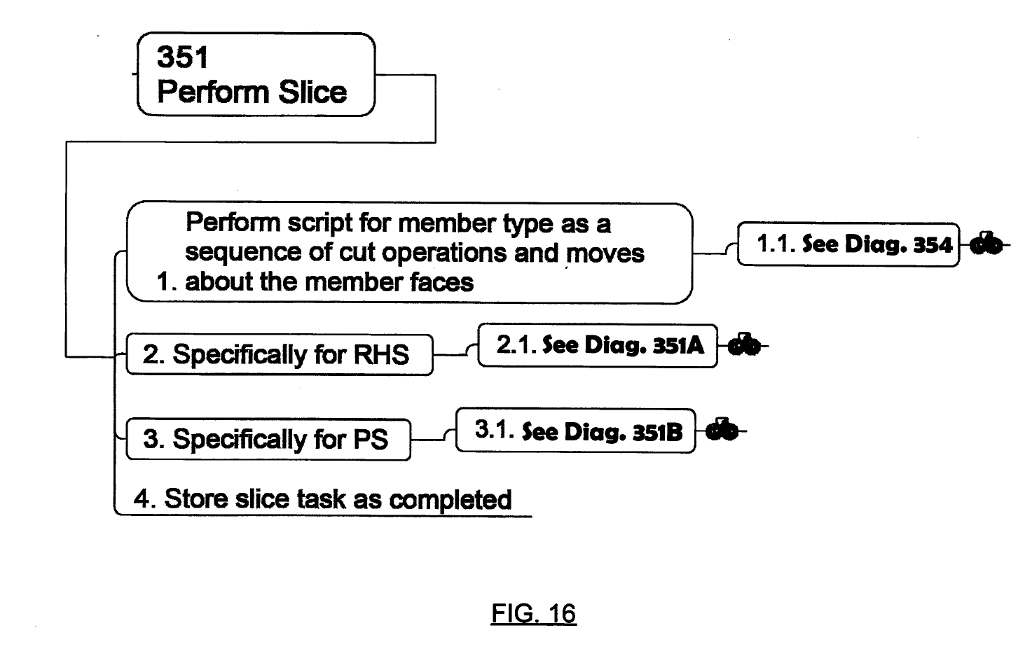

Returning again to FIG. 11 (300 Step 6), if the task list includes a task for performing an angle slice at the start of the material then the material is sliced accordingly. Alternatively, at (step 6.2) the operator is prompted to advise if the end of the member is a “green end”, i.e. not a correct square end or unacceptable for some other reason. FIG. 15 is a screen shot of the display that is generated to prompt the human operator to advise whether or not the end of the member is a green end or not.

If the human operator indicates that the end is a green end then the system performs a slice on the end in order to render it square. Each member type has its own script for performing a slice. The script includes instructions for moving the plasma cutter and its gantry, and if necessary rotating the member in the vises, for the plasma cutter to approach the end of the member and cut off an end slice.

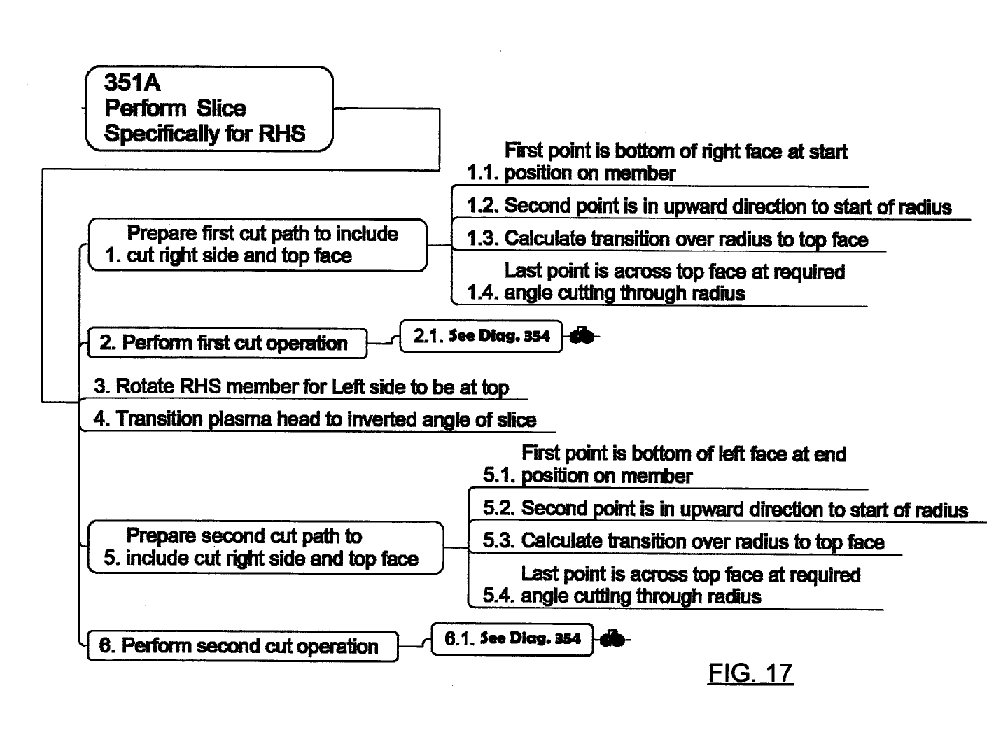

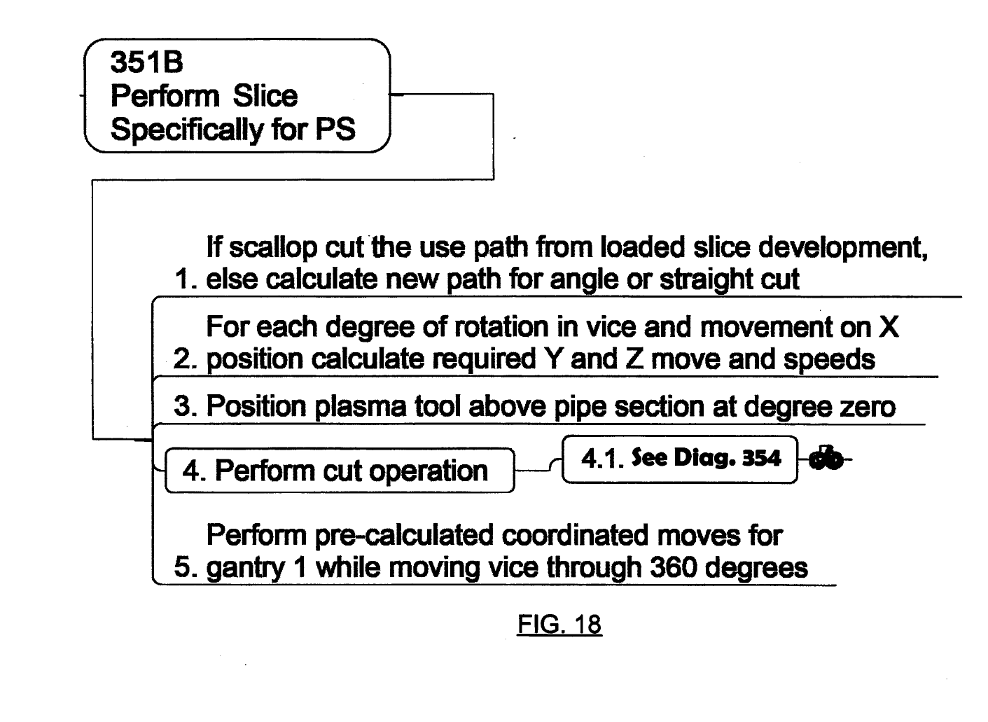

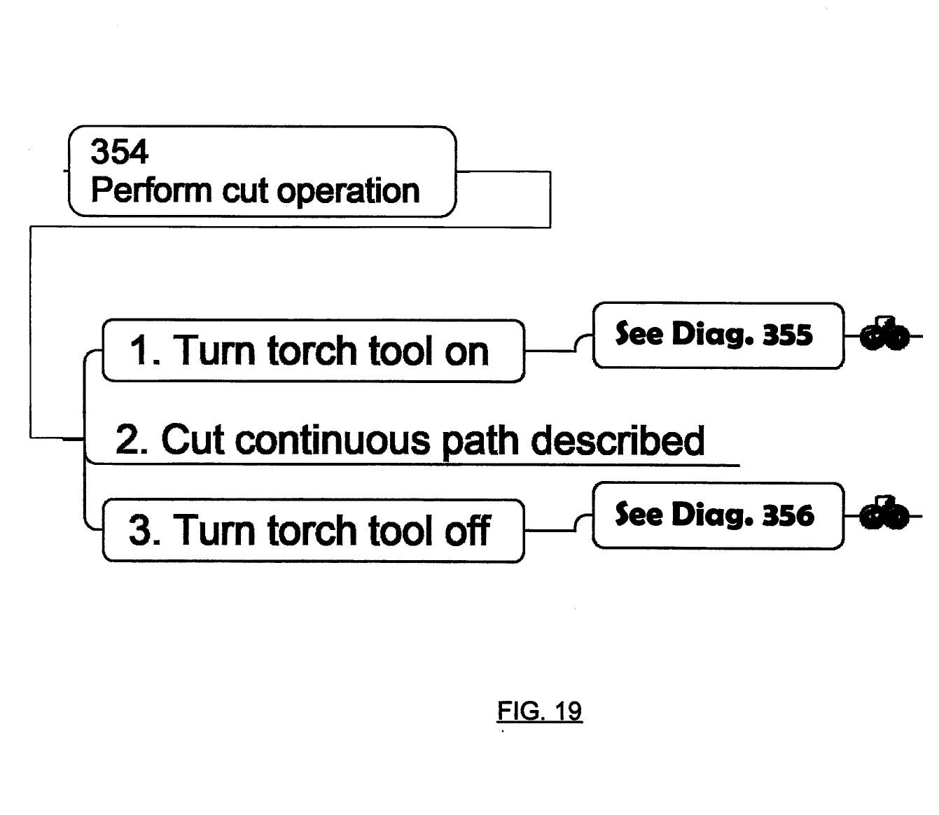

The details of the steps of the slice operation for each type of member are set out in 351 (FIG. 16); 351A (FIG. 17), 351B (FIG. 18), and 354 (FIG. 19).

Referring again to FIG. 11 (300), after the slice has been performed a new zero coordinate for the member is updated and mapped to world coordinate system.

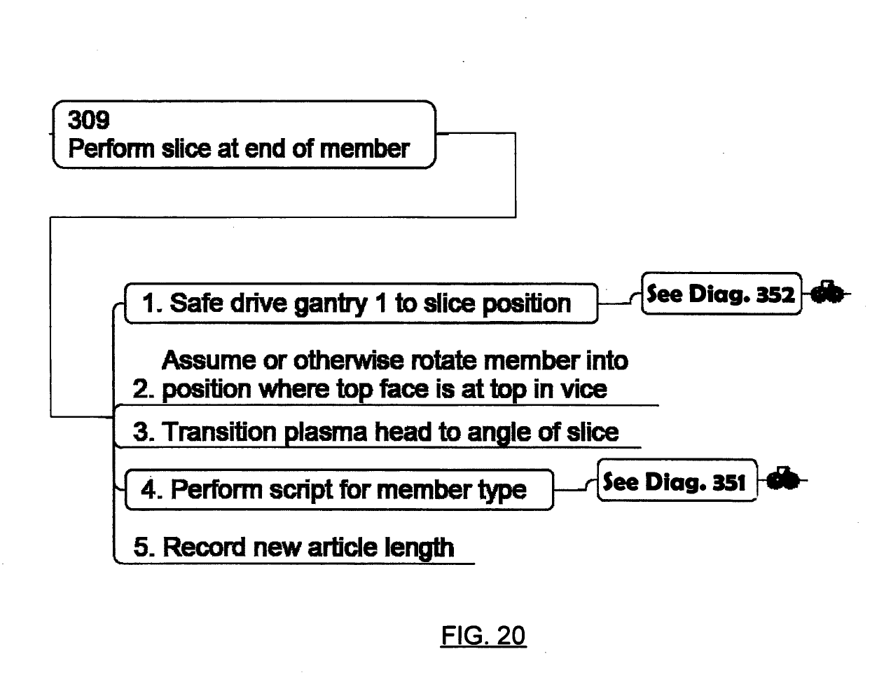

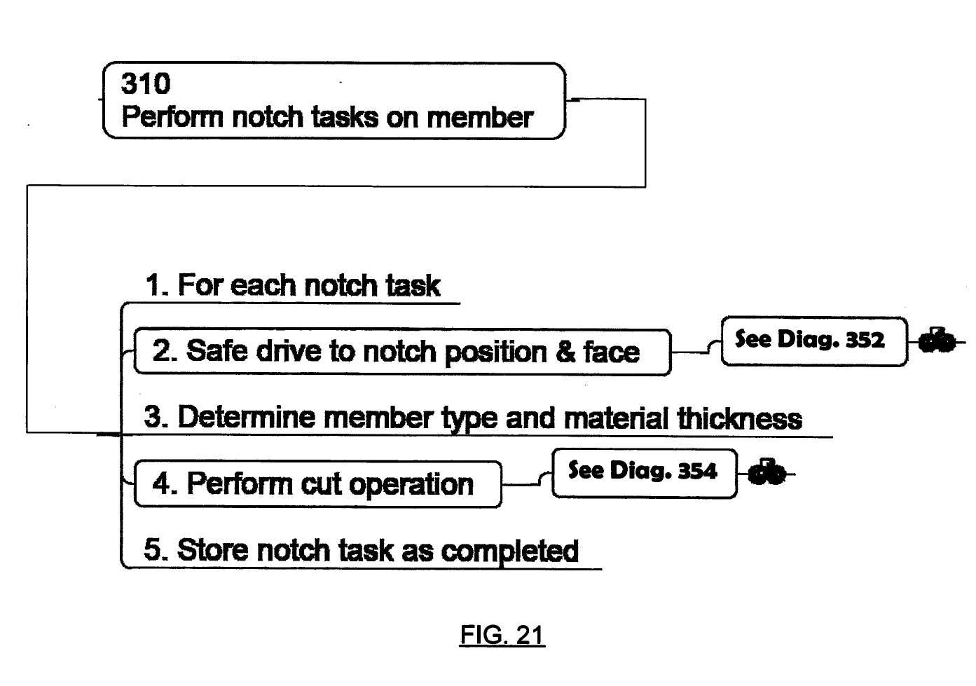

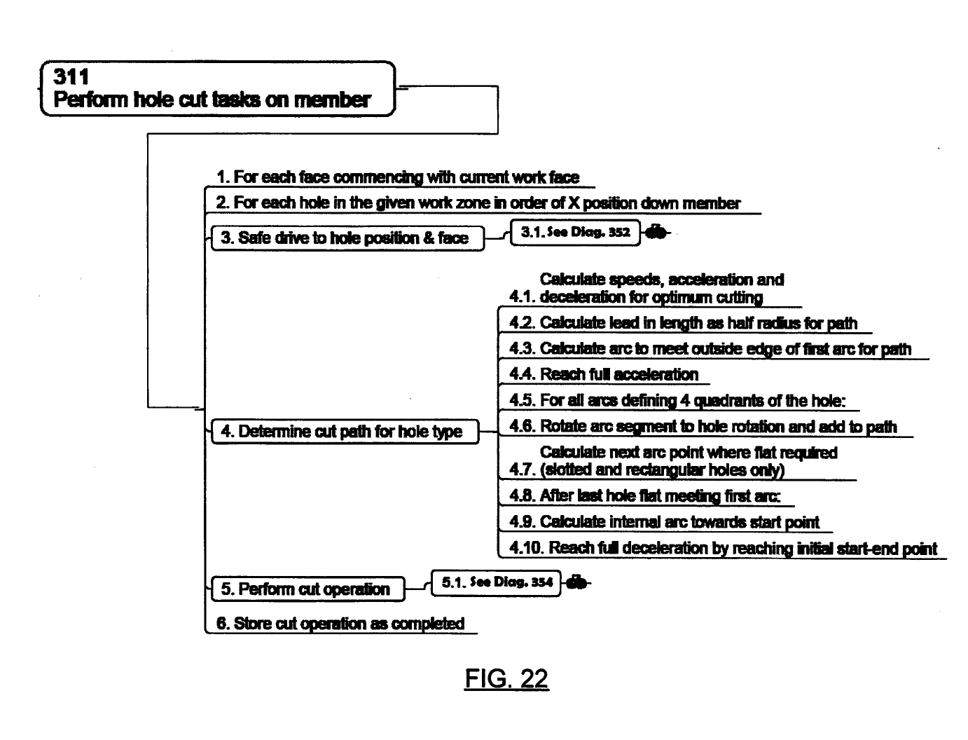

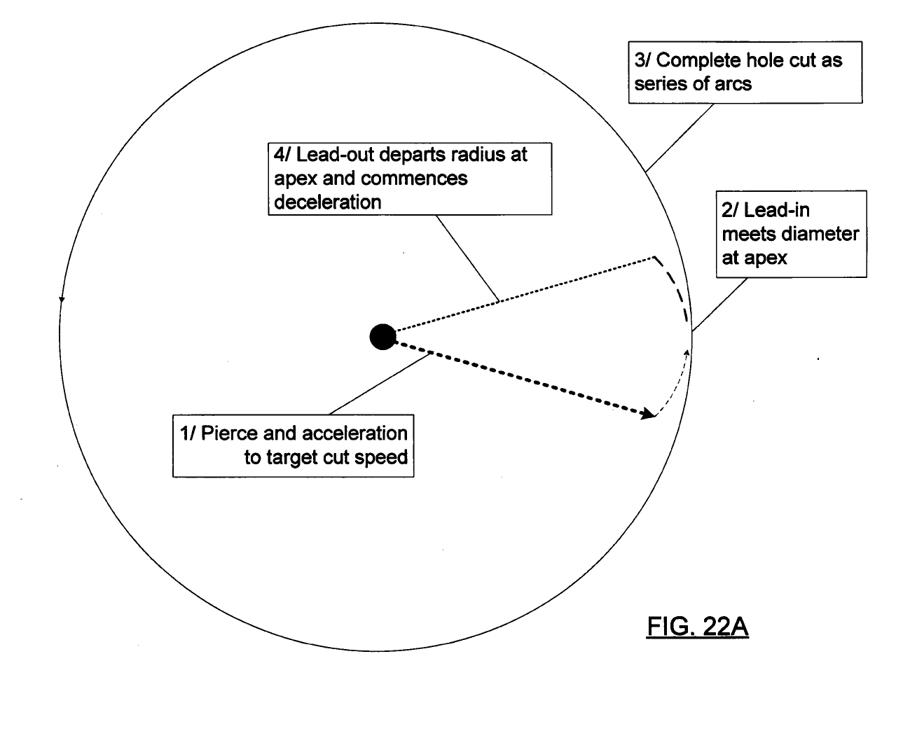

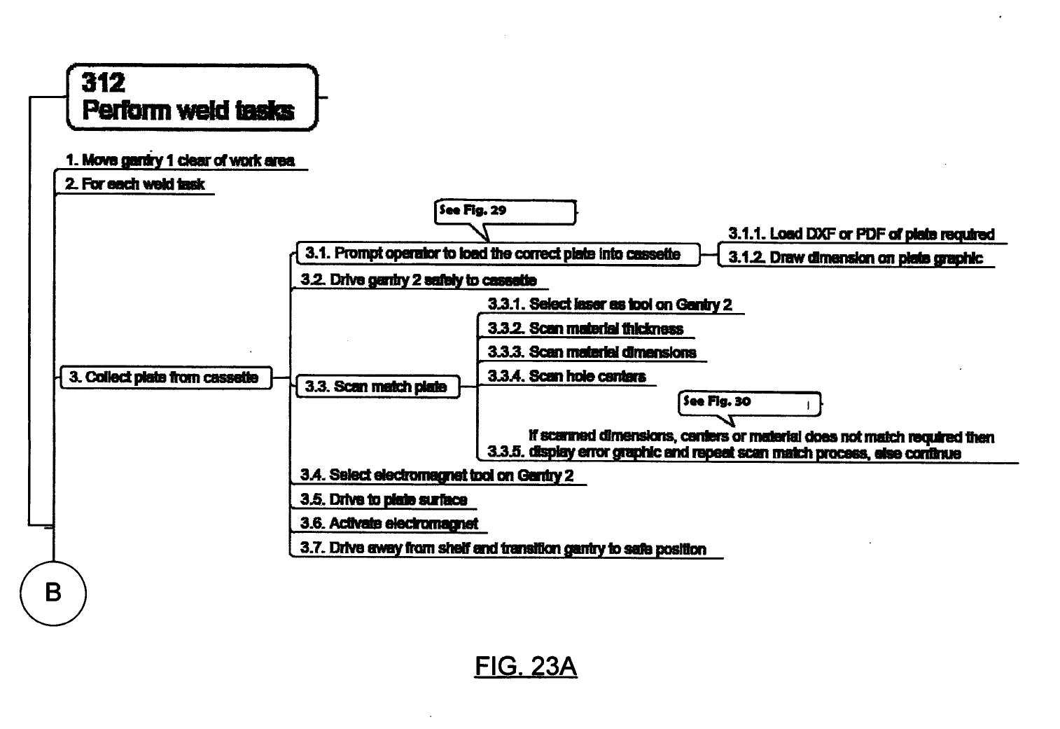

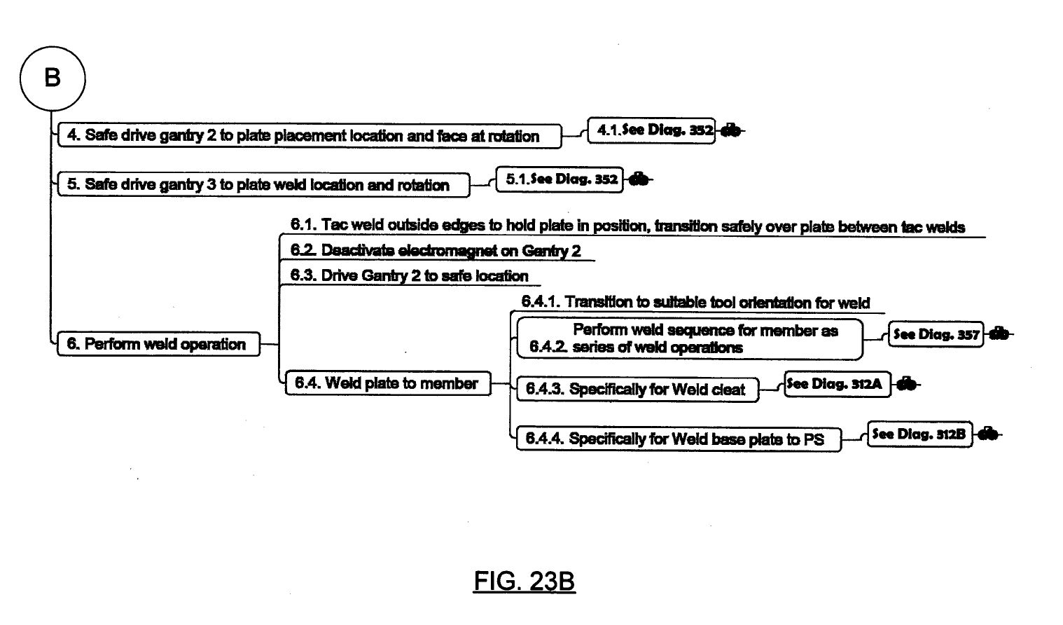

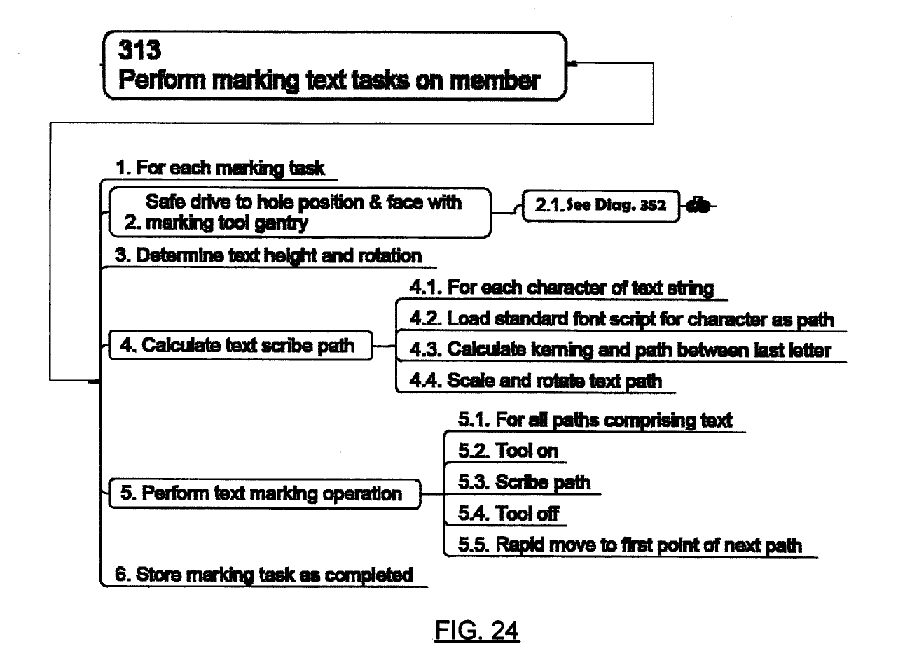

The member is then drawn through the vises to the required cut length as described in points 8.1 to 8.6 of FIG. 12. Further end slices, notches, hole cutting, welding and text marking is then performed as set out in 309 (FIG. 20), 310 (FIG. 21), 311 (FIG. 22), 312 (FIG. 23A, 23B), 313 (FIG. 24).

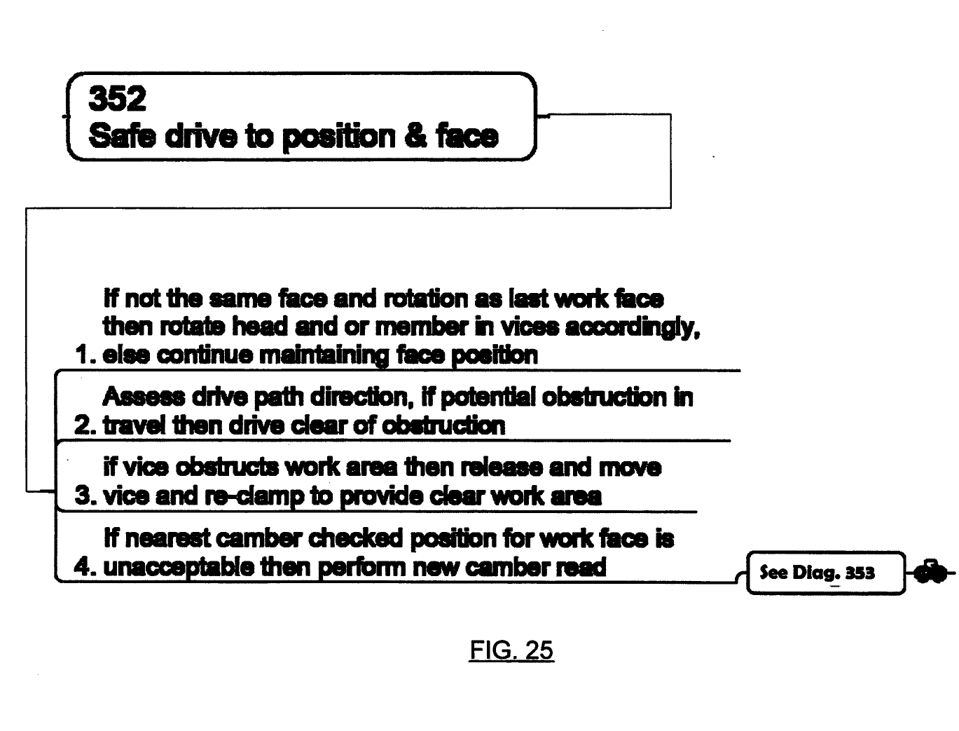

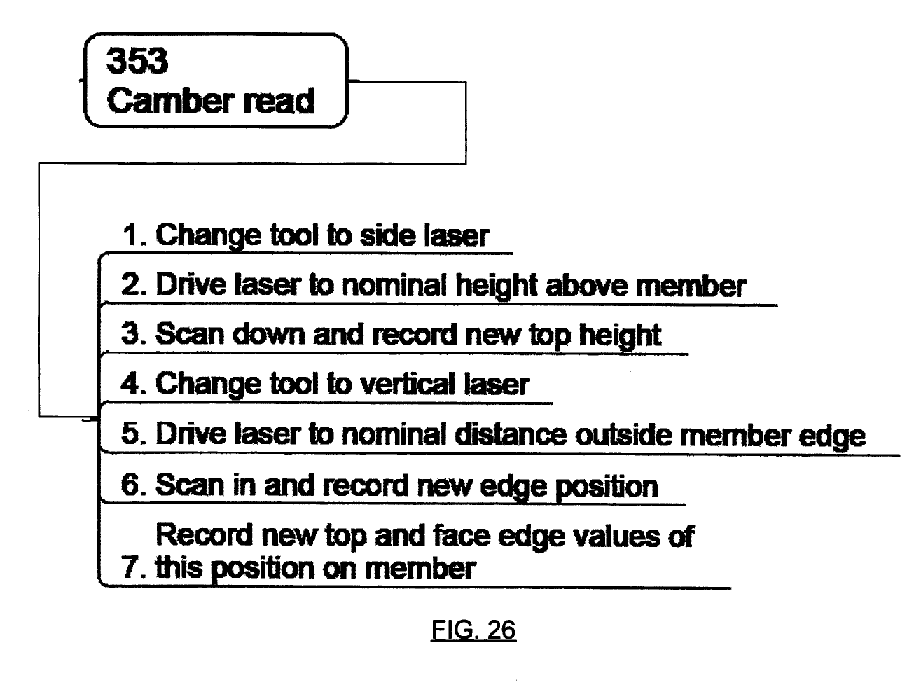

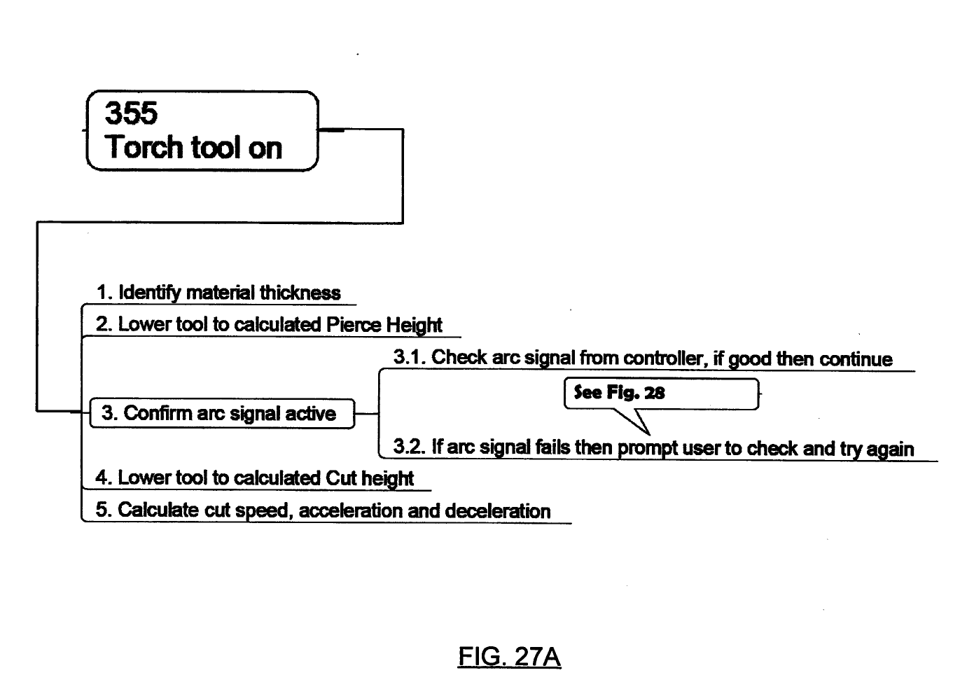

In performing the various tasks it is necessary to move the gantries along their rails in order to bring the various tool heads to positions for working on the member. In order to move the gantries a Safe Drive routine is provided as detailed in 352 (FIG. 25). The Safe Drive checks that the gantry to be moved can reach its destination unobstructed. If there is an obstruction, for example another gantry located between the gantry to be moved and the work area, then the Safe Drive routine moves the obstructing gantry out of the way, i.e. beyond the work area. The Safe Drive routine also checks to see if one of the vises is obstructing the work area. If it is then the vise clamp is opened and the vise is moved to clear the work area. As previously mentioned, the positions of all of the vises, gantries and work heads are continuously monitored and updated during the task operations.

Steel structural members have a slight camber, i.e. longitudinal curvature, so that they are not perfectly straight. The Safe Drive routine (352-FIG. 25) calls a Camber Read routine (353 FIG. 26) which uses one of the gantry's lasers to scan the height of the member and check for the work area position taking into account the camber. The Camber Read routine records new top face and face edge values for the work position on the member in order that the tool is brought to the correct location on the member by the Safe Drive routine.

The diagram 311 (FIG. 22) documents the routine for carrying out the hole cut tasks on a member. In order to minimise the number of gantry and vise movements, all the hole cut tasks in a given work zone are carried out before proceeding to a subsequent work zone. A work zone is a calculated permitted box for travel in 3 dimensions at a given plane where the machine can freely operate without concern for obstructions. As an example, the area in front of the first vice at the vice position and a work plane is a work zone. This zone would be larger if the vice was further forward. The work zone would change should the work plane change from working on the right side face to the top face, likewise if the member was rotated.

Should the machine move and operate between the two vices, the work zone would be the extremities of travel between the vices.

Steps 4.1 to 4.10 of diagram 311 (FIG. 22), set out the method for cutting a hole. It will be realised that the cutting element of any cutting tool has a kerf. A kerf is the width of the cut made by the cutter. The plasma cutting tool of the Ironman has a kerf which is taken into account when calculating the plasma cutting tool path. The path that is calculated follows the contour shown in FIG. 22A. It includes a lead in, from within the perimeter of the hole so that the cutter is not turned on near the hole periphery, which would result in an uneven hole. The designed approach to hole cutting is necessary to achieve a true round hole.

If the application of the plasma tool was to commence cutting on the outside diameter, the hole would suffer imperfections.

With reference to FIG. 22A, firstly, the pierce of the material by the plasma is performed stationary. The time taken from pierce to motion will cause material to bum out a larger kerf cut resulting in a “key hole” appearance. Similarly, as the machine accelerates to target cut speed, the kerf is large and narrows with acceleration causing inconsistency in the outside diameter at the commencement of acceleration and inversely, during deceleration.

In a preferred embodiment the method for cutting a true round hole is to take these areas of imperfection inside the waste of the hole and to cut the hole according to the following procedure:
1. Commencing the pierce at the hole center
2. Reaching target speed during travel from the hole center to the outside edge.
3. Alleviating imperfections from an otherwise sudden change in direction by commencing a smooth arc from the inside and merging with the outside edge at the apex of this curve.
4. When completing the hole, the final outside arc is extended to continue arcing internally into the waste at the same apex as the first external arc whilst decelerating.

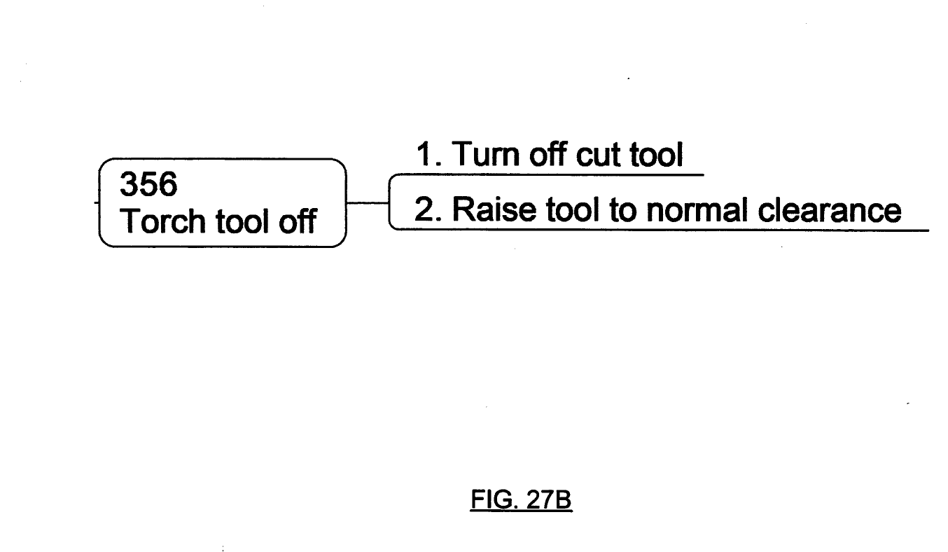

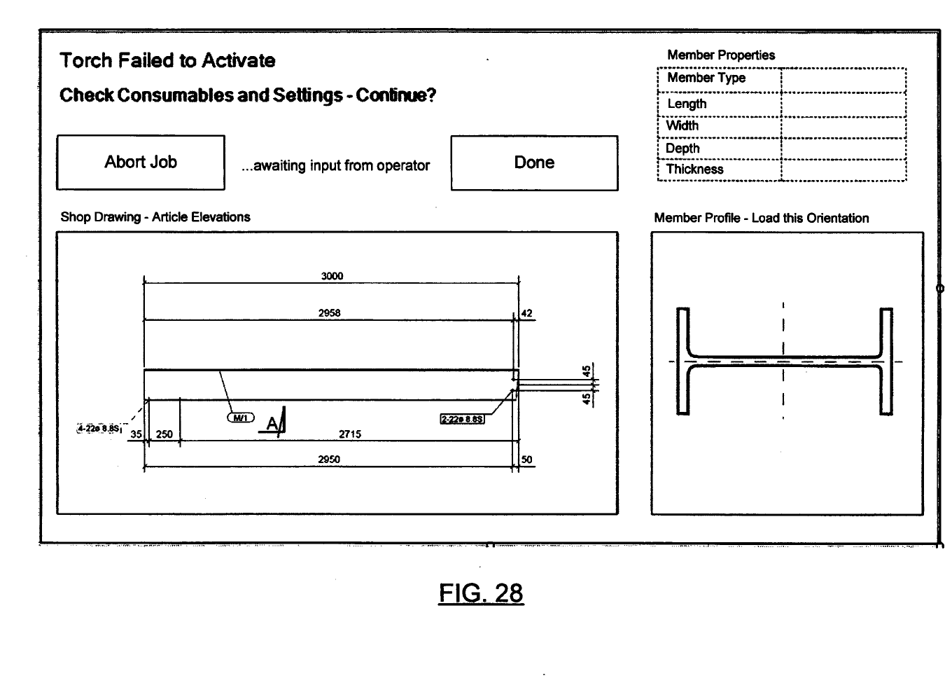

At step 5 of diagram 311 (FIG. 22) a call is made to a cut operation routine 354 (FIG. 19). The Cut Operation routine turns on the torch, i.e. the plasma cutter, tool, cuts the continuous path that has been previously calculated and then turns the torch off. The process for turning the torch on is set out in diagram 355 (FIG. 27A) and the process for turning off the torch is set out in diagram 356 (FIG. 27B). The steps of the Torch On process include confirming that the arc signal, which is fed back to the computer system from a sensor on the plasma cutter torch, is on. If the arc signal fails then (as shown in step 3.2 of diagram 355 FIG. 27) a screen, as shown in FIG. 28 is displayed to prompt the operator to check the torch and confirm when it is working properly.

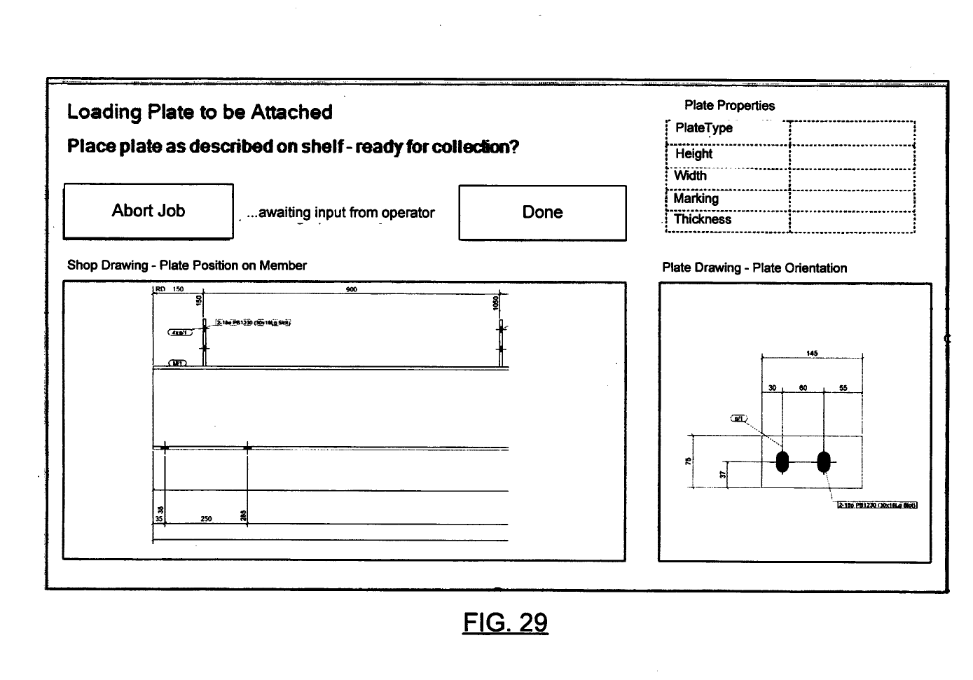

Diagram 312 (FIGS. 23A, 23B) sets out the procedure for performing weld tasks. This involves welding plates, for example cleats and reinforcement plates to the member. Initially gantry 1 is moved clear of the work area. A plate is then collected from a plate cassette or she which is mounted on to or adjacent the Ironman. At step 3.1 a screen as shown in FIG. 29 is displayed to prompt the operator to check that the correct plate is available on the shelf. The screen includes a drawing of the plate and a shop drawing showing the plate positioned where it is to be welded to the member.

Once the operator has confirmed that the correct plate is indeed ready for collection Gantry 2 (i.e. item 21 of FIG. 2A) is moved to position adjacent the cassette where its laser tool scans to check the plates material's thickness, dimensions and hole centres.

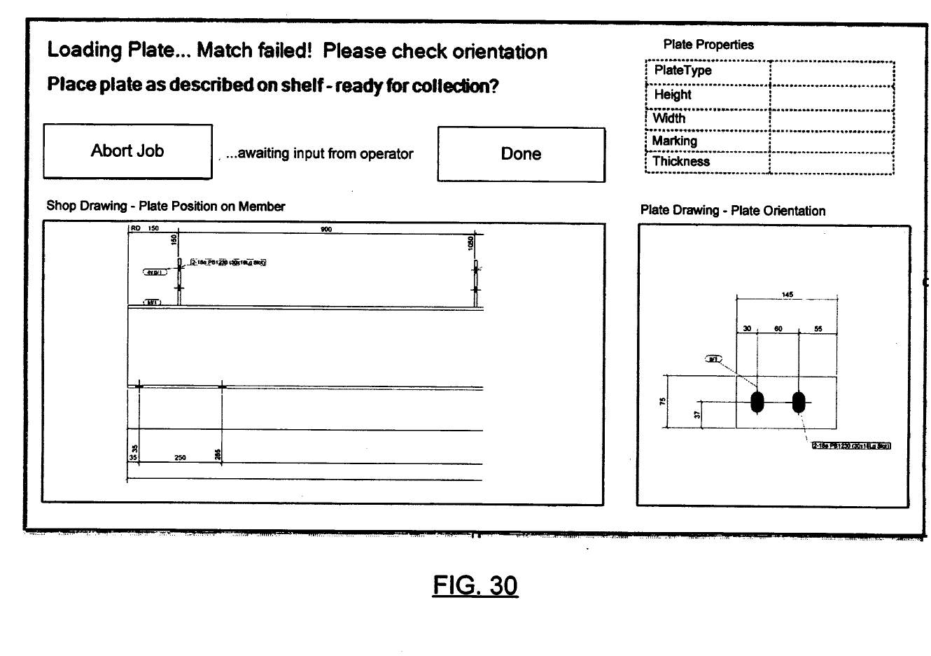

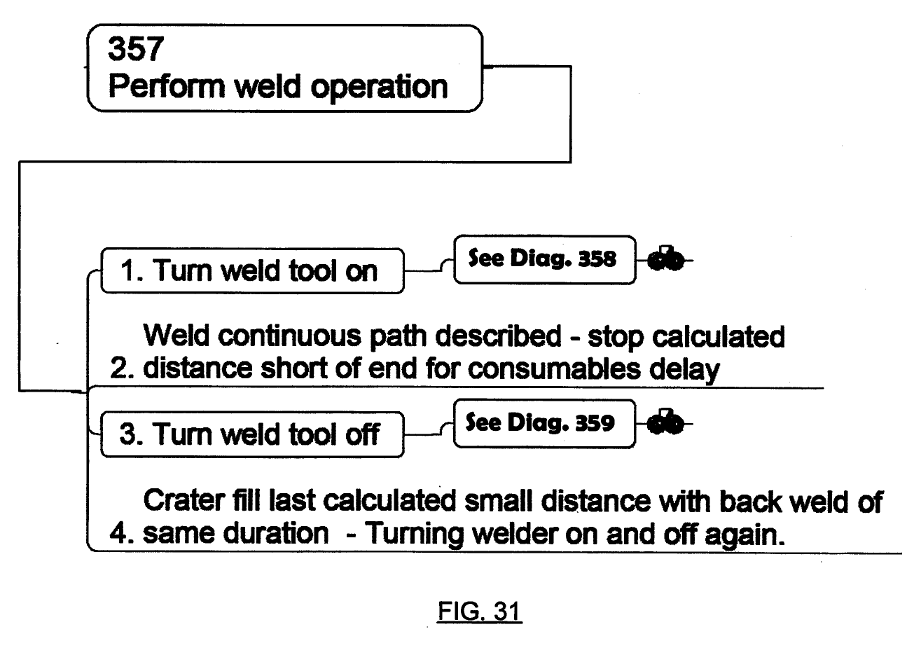

If the information from the scan does not coincide with the plate information for the current task then an error plate message is displayed as shown in FIG. 30.

Once a correct plate is confirmed as being in the cassette then an electromagnet tool on Gantry 2 is activated to pick up the plate and the gantry is driven to a safe position (steps 3.4 to 3.7). At step 4 the Safe Drive command is called to move Gantry 2, thereby moving the plate to be welded, to the placement location on the member for welding. Gantry 3 (i.e. item 23 of FIG. 2A), which has a tool head that is fitted with a welding tool is then moved to the plate weld location. While the electromagnet of Gantry 2 holds the plate in position a tack weld is performed by the welding tool of Gantry 3. The electromagnet is then deactivated and Gantry 2 is moved out of the work area (steps 6.1 to 6.3 312 FIG. 23B).

At step 6.4.1 the tool head of the gantry is moved to a suitable orientation for it to commence the weld. The tool head is rotatable and the may also be slid up and down and left and right on the gantry, as well as moving the gantry forward and backward along its rails. These movements are all powered by motors of the Ironman. Consequently the step of moving the welding tool to a suitable orientation involves operating and monitoring the various motors to achieve the desired position set out in the task data.

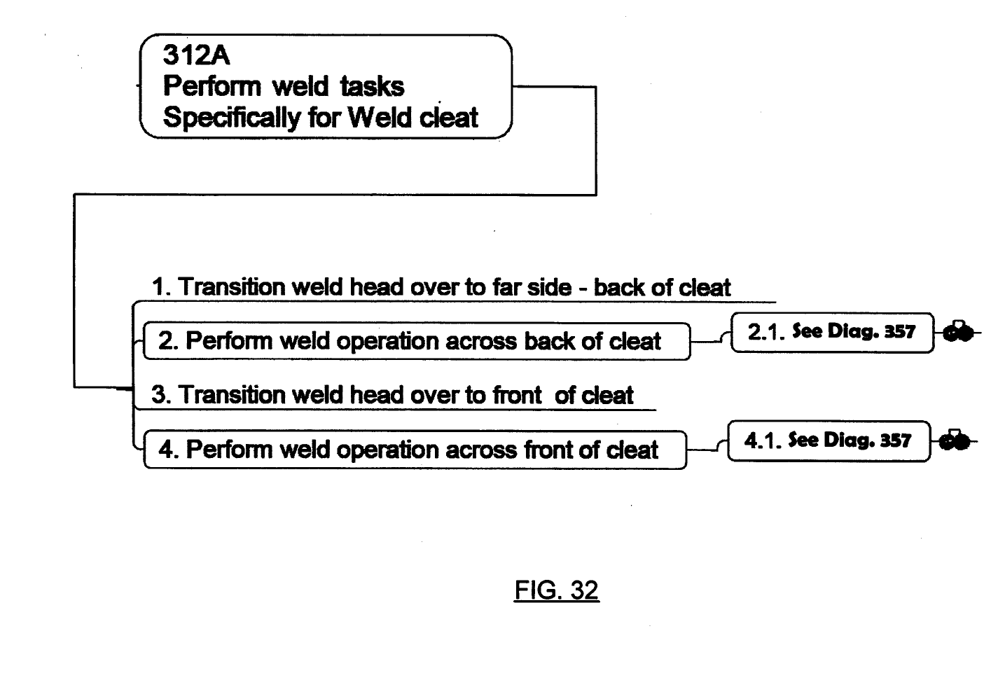

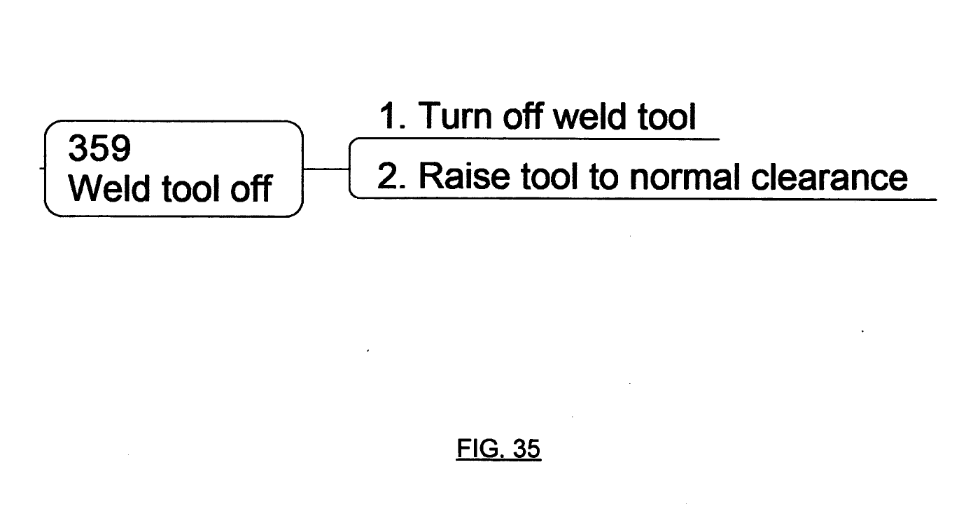

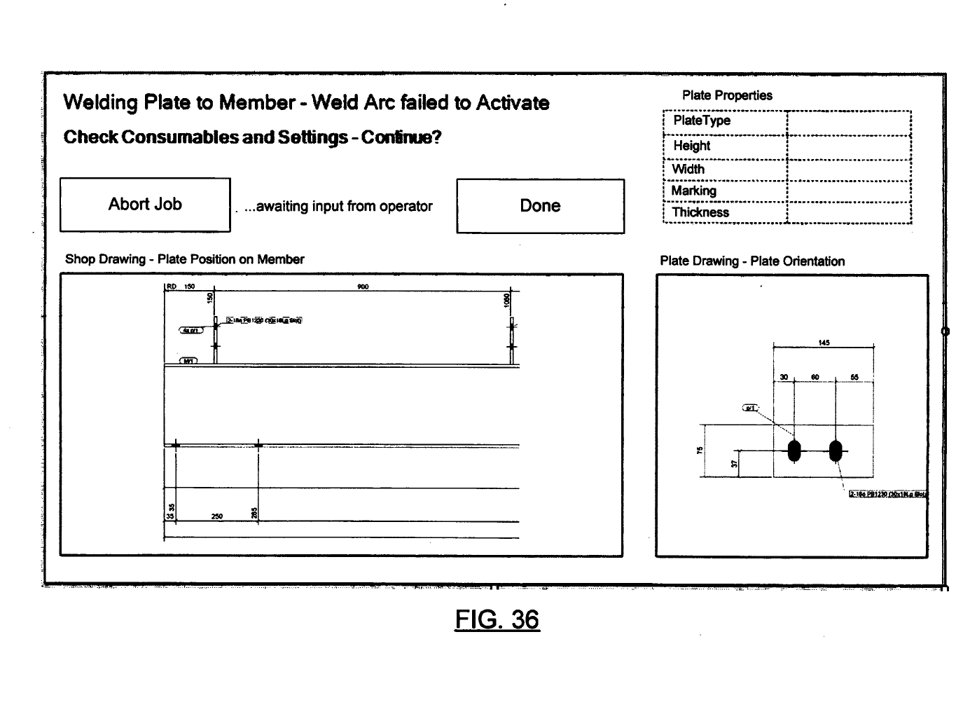

At step 6.4.2 the weld is performed as a series of weld operations which are described in diagram 357 (FIG. 31). The weld operation sequence (diagram 357) calls sub-routines 358 (FIG. 34) and 359 (FIG. 35) to turn the weld tool on and off. In step 5 of the Weld Tool On routine 358 (FIG. 34) a check is performed to determine that the weld tools arc signal is present. If it's not present then a screen is displayed (FIG. 35) to prompt the operator to check the weld tools consumables and settings and to confirm once that has been done.

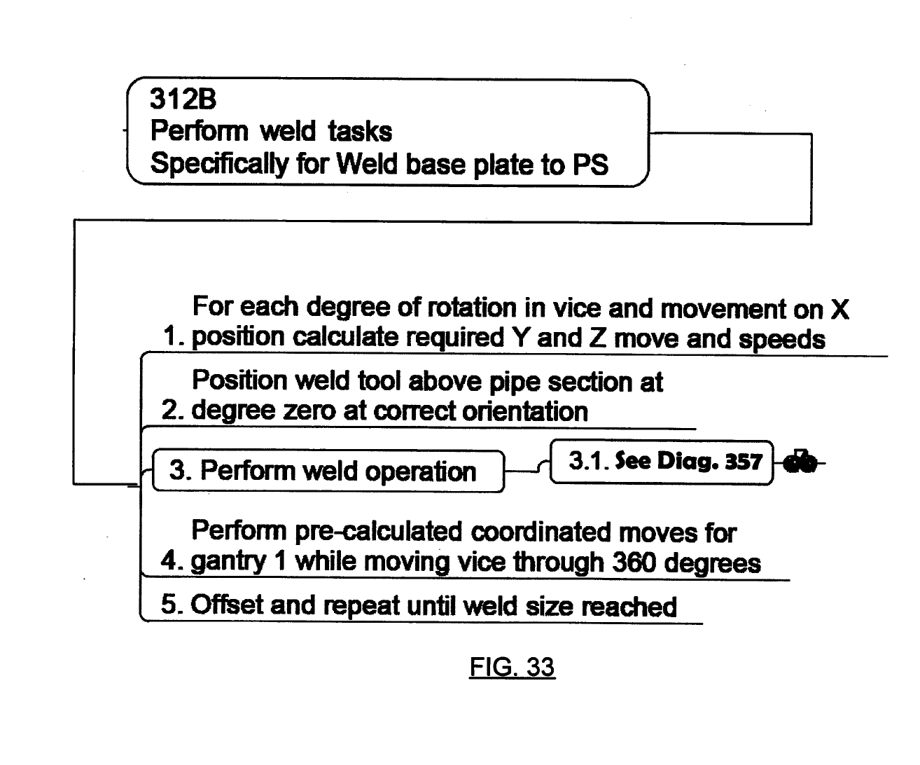

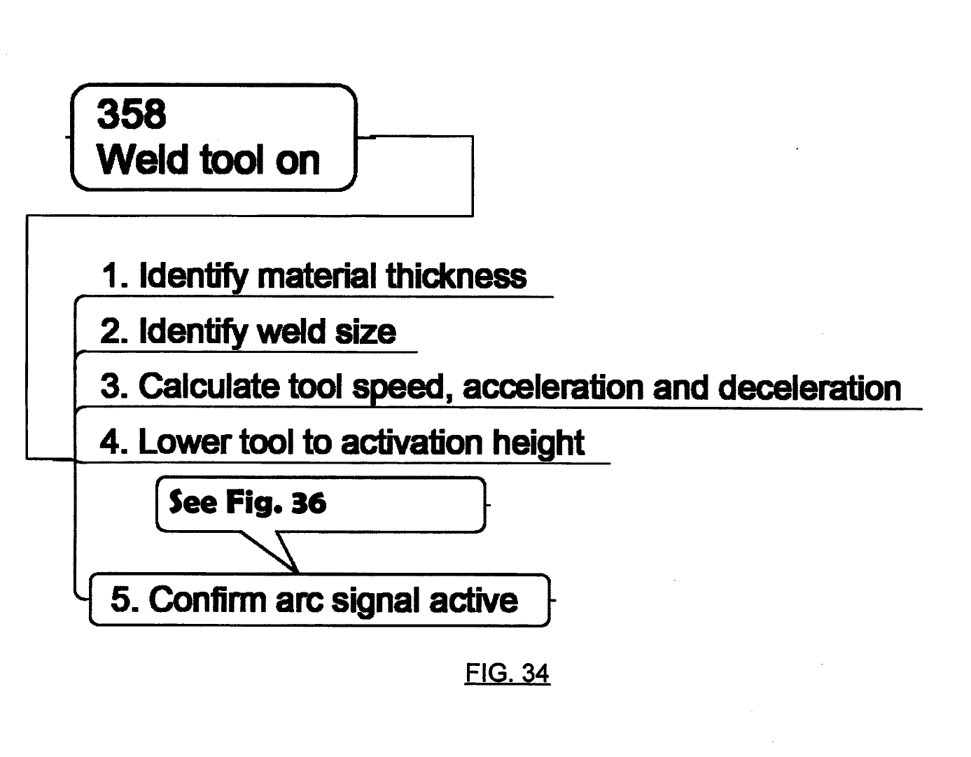

Supplementary steps, 6.4.3, 6.4.4 for specifically welding a cleat and a base plate are set out in diagram 312A (FIG. 32) and diagram 312B (FIG. 33), respectively.

It will be realised that a computer supervised fabrication method according to an embodiment of the present invention provides a great time saving on prior art prior art methods wherein a tradesman fabricated articles from a steel beam or other primary member from shop drawings.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect. The invention is, therefore, recited in any of its forms or modifications within the proper scope of the statements comprising the Summary of Invention section set out herein and the appended claims.

1. A computer supervised method of fabricating articles defined in an electronic information source with a computer in communication with a computer controllable steel fabrication machine of a type including at least one assembly for rotating a primary member under control of said computer, the method including operating the computer to:
extract data from said information source including data defining primary members corresponding to each article;
determine tasks to be performed on the primary members by said fabrication machine to transform them into the articles; and
transmit a sequence of commands to said machine for carrying out said tasks on the primary members to thereby fabricate said articles,
wherein the sequence of commands includes commands for rotating the primary member for access by tools of said machine.

2. A method according to claim 1, wherein the step of extracting data from the information source includes determining secondary members attached to the primary members.

3. A method according to claim 2, wherein if a secondary member is determined to be attached to a primary member as defined in said information source the tasks to be performed will include welding the secondary member to the primary member.

4. A method according to claim 4 including operating the computer to generate a fabrication shop drawing electronic file of each article from the digital information source for a human operator to refer to.

5. A method according to claim 4, including operating the computer to present the fabrication shop drawing on a computer display to the human operator prior to and/or during the step of carrying out the tasks on the primary member.

6. A method according to claim 1, including operating the computer to cause said machine to check that a primary member is correctly loaded in said machine.

7. A method according to claim 6, wherein said step to check that the primary member is correctly loaded includes operating a laser of said machine to check that the primary member is correctly loaded.

8. A method according to claim 7, including operating the computer to command the laser to perform checks to determine camber of the member to thereby allow for compensation for camber when carrying out the tasks.

9. A method according to claim 6 including operating the computer to check a cross section of the loaded member to confirm that the correct member corresponding to the tasks to be carried out is loaded in said machine.

10. A method according claim 2, including operating the computer to check that a secondary member has been correctly selected prior to welding it to a primary member.

11. A method according to claim 10, wherein the step of checking the correctness of the secondary member includes operating a laser of said machine.

12. A method according to claim 6, including operating the computer to display a prompt for a human operator to confirm that ends of the member are true, for example square or at a predetermined angle.

13. A method according to claim 12, wherein if the human operator responds that an end of the member is not true then the method includes operating the computer to cause the fabrication machine to render the end true.

14. A method according to claim 1, including operating the computer to monitor signals from the tools of the fabrication machine to confirm correct operation thereof.

15. A method according to claim 14, wherein upon a tool being detected to not be operating correctly the computer is operated to display a prompt for the human operator to check the tool.

16. A method according to claim 1 wherein the at least one assembly for rotating the primary member can be translated under control of the computer and wherein said machine includes one or more gantries that can also be translated under control of the computer, the method including operating the computer to move said assembly for rotating and one or more gantries to thereby clear a path to ensure that a tool head for carrying out the next task can be moved to a work area on the member unobstructed.

17. A method according to claim 1, wherein the step of operating the computer to extract data from said information source includes extracting identifiers for the primary members.

18. A method according to claim 17, including operating the computer to cause the fabrication machine to mark the primary members with markings corresponding to the identifiers for visual identification by human operators.

19. A computer software product comprising a computer readable media bearing tangible machine readable instructions for the computer to implement the method of any one of the preceding claims.

20. A computer programmed to implement a method according to claim 1.

21. A method for processing a primary member with a computer controlled fabrication machine to thereby transform the primary member into a corresponding article, the method comprising:
ensuring that the primary member is correctly loaded into the machine; and
performing a sequence of predetermined tasks on the primary member with the fabrication machine for production of the corresponding article; wherein the tasks include attaching secondary members to the primary member.

22. A computer implemented method of fabricating articles defined in a digital information source, the method including:
extracting data from said information source including primary members corresponding to each article;
determining tasks to be performed on the primary members to transform them into the articles; and
producing a sequence of commands for carrying out said tasks on the primary members with a computer controlled fabrication machine to thereby produce the articles from said members.

23. A method for extracting data for operating a fabrication machine from an information source defining a number of articles, the method including the steps of:
extracting a member type for a primary member corresponding to each article; and
determining tasks to be performed upon primary members to produce corresponding articles taking into account the member type.

24. A computer software product comprising a computer readable media bearing tangible machine readable instructions for the computer to implement the method of claim 21.

25. A computer programmed to implement a method according to claim 21.
